(19) United States
(12) Patent Application Publication
(10) Pub. No.: US 2025/0052645 A1
(43) Pub. Date: Feb. 13, 2025

(54) EXTRACTION OF LIQUID FROM PIERCEABLE LIQUID STORAGE CONTAINER

(71) Applicant: OSLER DIAGNOSTICS LIMITED, Oxford (GB)

(72) Inventors: Barry LILLIS, Oxford (GB); Jasper MALINSON, Oxford (GB); Jimishkumar PATEL, Oxford (GB); Myles WHITING, Oxford (GB); Amanda PUNIM, Oxford (GB); Dylann CERIANI, Oxford (GB)

(21) Appl. No.: 18/293,265

(22) PCT Filed: Jul. 29, 2022
(86) PCT No.: PCT/EP2022/071431

§ 371 Date: Jan. 29, 2024

Related U.S. Application Data
(60) Provisional application No. 63/227,154, filed on Jul. 29, 2021.

(51) Int. Cl. G01N 1/14

(52) U.S. Cl. CPC G01N 1/14

(57) ABSTRACT

Embodiments described herein relate to a liquid extraction device for extracting liquid from a liquid storage container, the liquid extraction device comprising: a receptacle configured to receive a portion of the liquid storage container; a liquid storage container interface housed within the receptacle, wherein the liquid storage container interface is configured to provide a fluidic connection to a volume of liquid within the liquid storage container when the liquid storage container is connected to the liquid storage container interface; and a safety mechanism actuatable from a first safety mechanism configuration to a second safety mechanism configuration, wherein the safety mechanism is configured to conceal the liquid storage container interface when the safety mechanism is in the first safety mechanism configuration, and wherein the safety mechanism is configured to reveal the liquid storage container interface when the safety mechanism in the second safety mechanism configuration.

### FIELD

The present disclosure relates to devices and methods for extracting liquid from a pierceable liquid storage container, such as a blood collection tube.

### BACKGROUND

Point-of-care diagnostic devices are typically used for carrying out diagnostic tests, such as immunoassays, on a biological sample (such as whole blood, blood serum or blood plasma). In order to carry out such diagnostic tests, the biological sample needs to be transferred to the diagnostic device. The diagnostic device is subsequently inserted into an analyser device (or instrument), which controls the movement of fluids (e.g. biological samples, reagents, buffer solutions, etc.) within the diagnostic device and conducts measurements of biomarkers, in order to conduct the diagnostic test.

Biological samples such as whole blood or blood plasma are typically collected from a subject using a pierceable liquid storage container such as a blood collection tube, also commonly referred to as a venous blood tube or as a Vacutainer (RTM). Existing systems for extracting liquid samples from blood collection tubes involve coupling the blood collection tube to the diagnostic device, and subsequently inserting the diagnostic device and coupled blood collection tube into the analyser device. Diagnostic tests can take several minutes to perform, meaning that any remaining quantity of biological sample within the blood collection tube cannot be used until the diagnostic device has been removed from the analyser device, following completion of the diagnostic test. Accordingly, a drawback of such existing systems is that a biological sample within a blood collection tube cannot be utilised until a particular diagnostic test has been completed.

Some existing systems include a needle that is configured to pierce a septum of a blood collection tube. A drawback of such existing systems is that there is a risk of injury to the user. In addition, there is a risk of contamination if the user injures themselves on the needle after it has been used for extracting blood from the blood collection tube.

Accordingly, there exists a need for devices for extracting liquid from a liquid storage container that can be safely and easily used by a user.

### SUMMARY

This summary introduces concepts that are described in more detail in the detailed description. It should not be used to identify essential features of the claimed subject matter, nor to limit the scope of the claimed subject matter.

According to one aspect of the present disclosure, there is provided a liquid extraction device for extracting liquid from a liquid storage container, the liquid extraction device comprising: a receptacle configured to receive a portion of the liquid storage container; a liquid storage container interface housed within the receptacle, wherein the liquid storage container interface is configured to provide a fluidic connection to a volume of liquid within the liquid storage container when the liquid storage container is connected to the liquid storage container interface; and a safety mechanism actuatable from a first safety mechanism configuration to a second safety mechanism configuration, wherein the safety mechanism is configured to conceal the liquid storage container interface when the safety mechanism is in the first safety mechanism configuration, and wherein the safety mechanism is configured to reveal the liquid storage container interface when the safety mechanism in the second safety mechanism configuration.

By concealing the liquid storage container interface (e.g. a piercing element such as a needle) when the safety mechanism is in the first safety mechanism configuration, the liquid storage container interface is not exposed, meaning that the user cannot injure themselves on the liquid storage container interface when the safety mechanism is in the first safety mechanism configuration.

The liquid storage container interface may comprise at least one needle configured to provide the fluidic connection to the volume of liquid within the liquid storage container.

The liquid extraction device may further comprise a resiliently deformable element configured to be deformed when the safety mechanism is actuated from the first safety mechanism configuration to the second safety mechanism configuration; wherein the resiliently deformable element is configured to bias the safety mechanism away from the second safety mechanism configuration towards the first safety mechanism configuration.

The resiliently deformable element ensures that the liquid storage container interface (e.g. a piercing element such as a needle) is re-concealed after the safety mechanism has been actuated to the second safety mechanism configuration. For example, if the liquid extraction device comprises a needle configured to extract blood from a blood collection tube, re-concealing the needle ensures that a user cannot injure themselves on a needle that has been in contact with potentially contaminated blood. This reduces the contamination risk for the user.

The safety mechanism may comprise a release mechanism configured to engage a portion of the receptacle when the safety mechanism is in the first safety mechanism configuration. The release mechanism ensures that the safety mechanism needs to be actively released in order to actuate it from its first configuration to its second configuration, thereby reducing the risk of accidentally exposing the needle. The release mechanism may be configured to permit actuation of the safety mechanism from the first safety mechanism configuration to the second safety mechanism configuration when the release mechanism is disengaged from the portion of the receptacle.

The release mechanism may comprise at least two clips, wherein the release mechanism is configured to be disengaged from the portion of the receptacle when a force is simultaneously applied to each of the at least two clips. By using two clips to which forces must be simultaneously applied, the release mechanism is more difficult to operate using a user's finger, reducing the risk of a user actuating the safety mechanism using their finger. The at least two clips may be configured to be actuated by an annular force profile, for example, a cap of a blood collection tube.

The liquid extraction device may further comprise a blocking element configured to: prevent actuation of the safety mechanism from the first safety mechanism configuration to the second safety mechanism configuration when the liquid extraction device is in a first orientation; and permit actuation of the safety mechanism from the first safety mechanism configuration to the second safety mechanism configuration when the liquid extraction device is in a second orientation different to the first orientation.

The blocking element ensures that the safety mechanism is actuated when the liquid extraction device is in a desired orientation (e.g. a substantially vertical orientation), and cannot be actuated when the liquid extraction device is not in the desired orientation. For example, permitting actuation of the safety mechanism when the liquid extraction device is in a vertical orientation ensures that the needle is in fluidic connection with a volume of blood within a blood collection tube.

The blocking element may be configured to engage a portion of the receptacle to prevent actuation of the safety mechanism from the first safety mechanism configuration to the second safety mechanism configuration when the liquid extraction device is in the first orientation. The second orientation may be a substantially vertical orientation.

The liquid extraction device may further comprise a liquid extraction mechanism actuatable from a first liquid extraction mechanism configuration to a second liquid extraction mechanism configuration, wherein the liquid extraction mechanism is configured to provide a pressure difference between a volume of gas in the liquid storage container and the liquid extraction outlet, when the liquid extraction mechanism is actuated from the first liquid extraction mechanism configuration to the second liquid extraction mechanism configuration.

By providing a pressure difference between a volume of gas in the liquid storage container (e.g. blood collection tube) and the liquid extraction outlet, liquid can be forced out of the liquid storage container by the pressure difference.

The safety mechanism may be configured to actuate the liquid extraction mechanism from the first liquid extraction mechanism configuration to the second liquid extraction mechanism configuration. Therefore, a single continued user action is required to both actuate the safety mechanism and the liquid extraction mechanism, thereby providing increased ease of use. The liquid extraction mechanism may be actuatable from the first liquid extraction mechanism configuration to the second liquid extraction mechanism configuration once the safety mechanism has been actuated to the second safety mechanism configuration.

The liquid extraction device may further comprise an first engagement mechanism configured to prevent actuation of the liquid extraction mechanism from the first liquid extraction mechanism configuration in a direction opposite to the direction of actuation from the first liquid extraction mechanism configuration to the second liquid extraction mechanism configuration. This prevents the liquid extraction mechanism from being pulled out of the first liquid extraction mechanism configuration.

The liquid extraction device may further comprise a second engagement mechanism configured to retain the liquid extraction mechanism in the second liquid extraction mechanism configuration once the liquid extraction mechanism has been actuated to the second liquid extraction mechanism configuration. The second engagement mechanism may provide an audible click when engaged. This allows a user to establish that the liquid extraction device has been actuated to a configuration in which liquid is extracted.

The safety mechanism may comprise an aperture; wherein the liquid storage container interface does not extend through the aperture in the safety mechanism when the safety mechanism is in the first safety mechanism configuration; and wherein the liquid storage container interface extends through the aperture in the safety mechanism when the safety mechanism is in the second safety mechanism configuration.

The safety mechanism may comprise: an actuatable platform having an aperture; wherein the actuatable platform is movable from a first configuration, in which the blood collection tube interface does not extend through the aperture, to a second configuration, in which the blood collection tube interface extends through the aperture. The actuatable platform may further comprise a cap configured to cover the aperture. The liquid storage container interface may be configured to open the cover when the actuatable platform is moved from the first configuration to the second configuration. The actuatable platform may be prevented from moving from the first configuration to the second configuration when a force is applied to the cover to move the actuatable platform.

The safety mechanism may comprise: an upper portion and a lower portion, wherein the upper portion and the lower portion cooperate to define the recess; wherein the lower portion is actuatable from a first position, in which the upper portion and the lower portion cooperate to prevent the blocking element from moving into the recess under gravity, to a second position, in which the upper portion and the lower portion are displaced apart, thereby enlarging the recess and allowing the blocking element to move into the recess under gravity.

The upper portion may comprise one or more holes, each of the one or more holes extending through the upper portion, and the lower portion may comprise one or more elongate elements (or protrusions), each of the one or more elongate elements configured to extend through a corresponding one of the one or more holes; wherein when the lower portion is in the first position, the one or more elongate elements extend through the one or more holes such that the ends of the one or more elongate elements protrude above an upper surface of the upper portion; and wherein the lower portion is actuatable from the first position to the second position by application of a force to the ends of the one or more elongate elements.

According to another aspect of the present disclosure, there is provided a liquid handling apparatus comprising: a liquid handling device comprising one or more conduits; and a liquid extraction device according to any of the above paragraphs; wherein the liquid extraction device is in fluidic communication with at least one of the one or more conduits.

The liquid handling device may be suitable for use in carrying out a diagnostic test. The liquid extraction device may be integrated within the liquid handling device. Alternatively, the liquid extraction device may be attachable to the liquid handling device. For example, the liquid extraction device may be removably attachable to the liquid handling device.

### BRIEF DESCRIPTION OF FIGURES

Specific embodiments are described below by way of example only and with reference to the accompanying drawings, in which:

FIG. 1 is a schematic diagram of a first liquid extraction device in fluidic communication with a cartridge.

FIG. 2A is a schematic diagram of an attachment between the first liquid extraction device and a cartridge.

FIG. 2B is a schematic diagram of an attachment between a second liquid extraction device and a cartridge.

FIG. 3A is an isometric view of a blood collection tube.

FIG. 3B is a section view of the blood collection tube shown in FIG. 3A.

FIG. 4A is an exploded view of a liquid extraction device comprising a safety mechanism.

FIG. 4B is a top view of the liquid extraction device shown in FIG. 4A.

FIG. 4C is an isometric section view of the liquid extraction device shown in FIG. 4A, taken through line A-A in FIG. 4B.

FIG. 4D is a front section view of the liquid extraction device shown in FIG. 4A, taken through line A-A in FIG. 4B.

FIG. 4E is an isometric section view of the liquid extraction device shown in FIG. 4A, taken through line B-B in FIG. 4B.

FIG. 4F is a front section view of the liquid extraction device shown in FIG. 4A, taken through line B-B in FIG. 4B.

FIG. 5A is a cutaway view of safety mechanism of the liquid extraction device, in which a cylinder of the liquid extraction device is not shown.

FIG. 5B is a section view of the safety mechanism shown in FIG. 5A.

FIG. 6 shows the position of the safety mechanism when a downwards force is applied to the safety mechanism, but not to one or more resiliently deformable clips of the safety mechanism.

FIG. 7A shows a blood collection tube in contact with the resiliently deformable clips of the safety mechanism.

FIGS. 7B to 7F show the position of the safety mechanism during actuation of the safety mechanism by application of a downwards force.

FIG. 7G is a schematic diagram showing blood being extracted by the liquid extraction device.

FIGS. 8A to 8D show the position of the safety mechanism when the downwards force applied to actuate the safety mechanism is released.

FIG. 8E shows the blood collection tube being removed from the liquid extraction device.

FIGS. 9A to 9C show the safety mechanism being actuated by different types of blood collection tubes.

FIG. 10 shows the blood collection tube being inserted into the liquid extraction device in a vertical orientation.

FIG. 11 shows a blocking element of the safety mechanism preventing actuation of the safety mechanism when the safety mechanism is in a horizontal orientation.

FIGS. 12A and 12B show the blocking element of the safety mechanism permitting actuation of the safety mechanism when the safety mechanism is in a substantially vertical orientation.

FIG. 13A is a sectional isometric view of an alternative safety mechanism.

FIG. 13B is a sectional side view of the safety mechanism shown in FIG. 13A.

FIG. 14A is a top view of a further alternative safety mechanism.

FIG. 14B is a sectional side view of the safety mechanism shown in FIG. 14A being actuated by a force applied by a blood collection tube.

FIG. 14C is a sectional side view of the safety mechanism shown in FIG. 14A being actuated by a force applied by a user's finger.

FIG. 15A is a top isometric view of a yet further alternative safety mechanism, comprising an upper safety mechanism portion and a lower safety mechanism portion.

FIG. 15B is a sectional side view of the lower safety mechanism portion of the safety mechanism shown in FIG. 15A in a first position.

FIG. 15C is a sectional side view of the lower safety mechanism portion of the safety mechanism shown in FIG. 15A in a second position.

### DETAILED DESCRIPTION

Implementations of the present disclosure are explained below with particular reference to extracting liquid from a blood collection tube. It will be appreciated, however, that the implementations described herein may also be used to extract liquid from other sealed liquid storage containers into which a liquid collection interface (such as a needle) may be inserted.

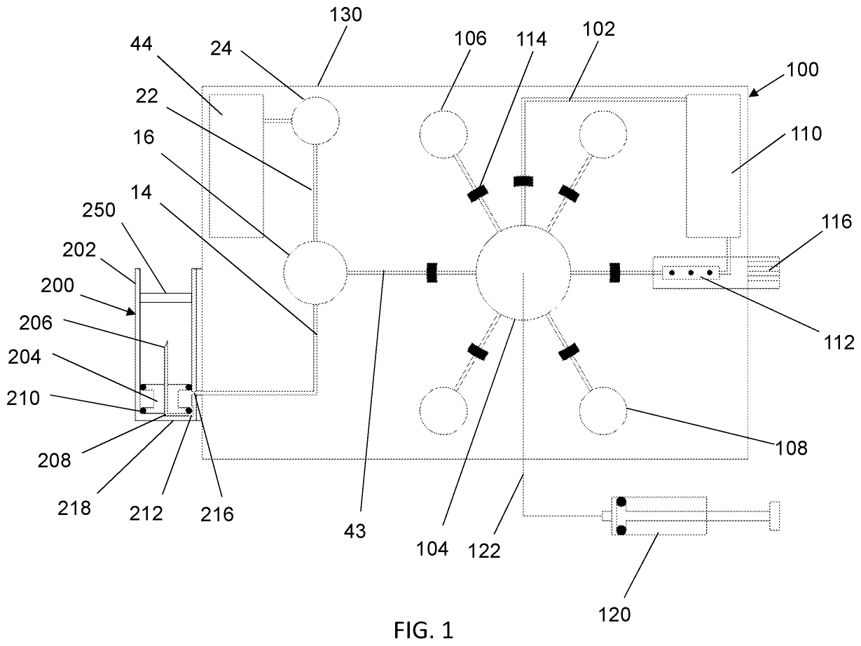

FIG. 1 is a schematic diagram showing a first liquid extraction device 200 in fluidic communication with a liquid handling device in the form of a cartridge 100. As shown in FIG. 1 the cartridge 100 includes a plurality of chambers in fluidic communication via a plurality of conduits 102. Specifically, the plurality of chambers includes a main chamber 104, a reagent chamber 106, a mixing chamber 108, a waste chamber 110, and a measurement chamber 112. The cartridge 100 also includes a plurality of valves 114, each of which controls fluid flow through a respective conduit 102. A sensor 116 is used to carry out a measurement (e.g. an electrochemical measurement) on a solution within the measurement chamber 112.

The flow of fluids between the chambers is controlled by an external pump 120 that is configured to apply a positive or negative pressure to the main chamber 104 via a pump conduit 122. The positive or negative pressure dispenses or aspirates fluid from one chamber to another, depending on which of the valves 114 is opened. For example, to aspirate reagent from the reagent chamber 106 to the main chamber 104 (e.g. for mixing with a sample), the valve 114 between the reagent chamber 106 and the main chamber 104 is opened, and a negative pressure is applied to the main chamber 104 by the pump 120.

The liquid extraction device 200 is in fluidic communication with the cartridge 100 via an inlet conduit 14. As explained in further detail below, the liquid extraction device 200 is configured to extract a liquid sample (e.g. blood) from a pierceable liquid storage container (e.g. a blood collection tube, not shown in FIG. 1). Once the liquid sample has been extracted from the liquid storage container, the liquid sample is transferred under pressure to a metering chamber 16 via the inlet conduit 14. The liquid sample can then be subsequently aspirated from the metering chamber 16 into the main chamber 104 via an outlet conduit 43, by application of a negative pressure using the pump 120.

The sample can then be combined with one or more reagents in the main chamber 104 by aspirating a reagent from the reagent chamber 106 to the main chamber 104. In order to mix the sample and reagent together, the solution may be repeatedly transferred between the main chamber 104 and the mixing chamber 108. The solution may then be dispensed to the measurement chamber 112, where an electrochemical measurement is carried out on the solution, using the sensor 116. Any waste solution from the main chamber 104 or the measurement chamber 112 may be transferred to the waste chamber 110.

The liquid extraction device 200 comprises a receptacle in the form of a cylinder 202 (or tube) in which a pierceable liquid storage container, such as a blood collection tube, is received. The liquid extraction device 200 also includes an actuatable liquid extraction mechanism in the form of a piston 204 that is actuatable within the cylinder 202 from a first liquid extraction mechanism configuration to a second liquid extraction mechanism configuration. In FIG. 1, the piston 204 is shown in the second liquid extraction mechanism configuration.

The piston 204 includes a sealing element in the form of an O-ring seal 210 configured to provide a seal between the piston 204 and the cylinder 202. The cylinder 202 includes a recess 212 configured to compromise the O-ring seal 210 by allowing air to flow around the O-ring seal 210, when the piston 204 is in the second configuration shown in FIG. 1.

The liquid extraction device 200 includes a liquid storage container interface (e.g. a blood collection tube interface) in the form of a needle 206 that is fixedly attached to the piston 204. The needle 206 is configured to pierce a liquid storage container (e.g. by piercing a septum of a blood collection tube). The needle 206 comprises a liquid extraction outlet 208 through which liquid extracted from the blood collection tube can flow.

The cylinder 202 also comprises an outlet 216 that allows liquid to be removed from the liquid extraction device 200 once it has been extracted from the blood collection tube. The outlet 216 is in fluidic communication with the inlet conduit 14, thereby allowing liquid to be transferred from the liquid extraction device 200 to the cartridge 100.

In the first liquid extraction mechanism, the piston 204 is located above the outlet 216 in the cylinder 202 (i.e. further from an end wall 218 of the cylinder 202 than shown in FIG. 1).

Together, the piston 204 and the cylinder 202 define a chamber. After connection of a blood collection tube to the needle 206, the volume of the chamber is reduced as the piston 204 is actuated from the first liquid extraction mechanism configuration to the second liquid extraction mechanism configuration. Once the piston 204 is actuated beyond the outlet 216, the reduction in volume of the chamber results in an increase in pressure of the air within the chamber, because the chamber is sealed by the O-ring seal 210. The increase in air pressure within the chamber forces air through the needle 206 and into the blood collection tube, which increases the pressure of a volume of gas within the blood collection tube. The increase in the pressure of air within the chamber and the blood collection tube continues as the piston 204 is actuated towards the second configuration.

Once the piston 204 is in the second configuration, the O-ring seal 210 is aligned with the recess 212 and is consequently compromised, meaning that the pressurised air within the chamber can flow around the O-ring seal 210. This reduces the pressure at the liquid extraction outlet 208, which is in fluidic communication with the chamber, thereby providing a pressure difference between the volume of gas within the blood collection tube, and the liquid extraction outlet 208. This difference in pressure forces liquid out of the blood collection tube via the needle 206, around the O-ring seal 210, and out of the liquid extraction device 200 via the outlet 216.

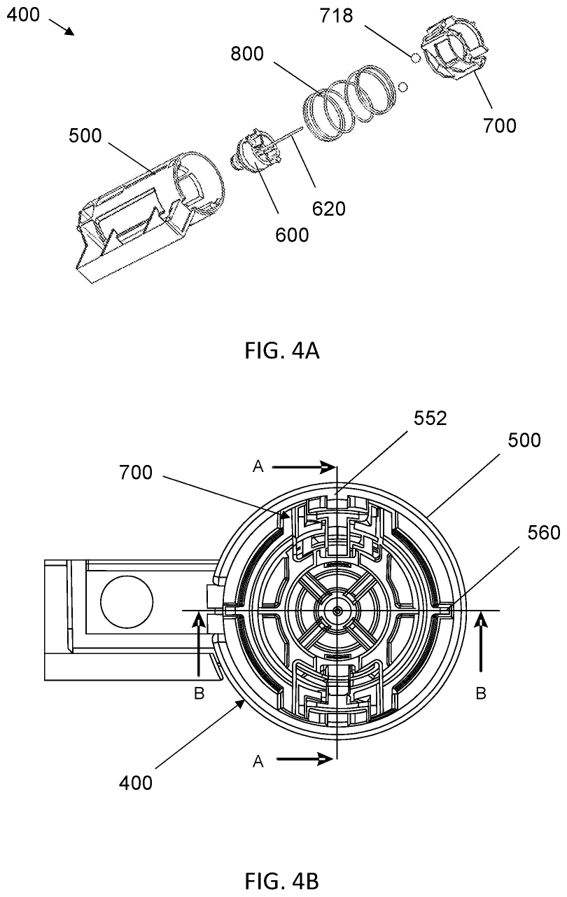

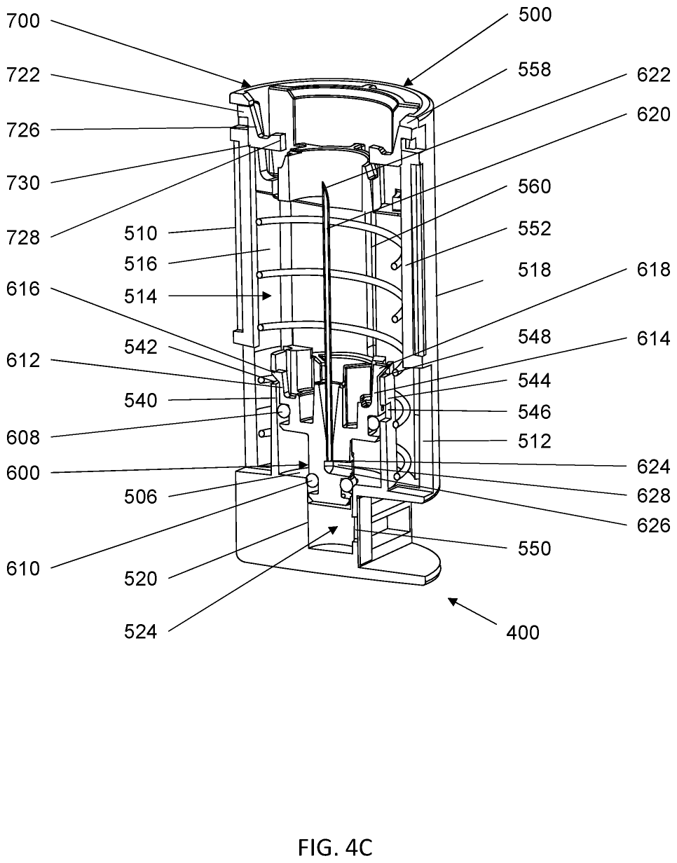

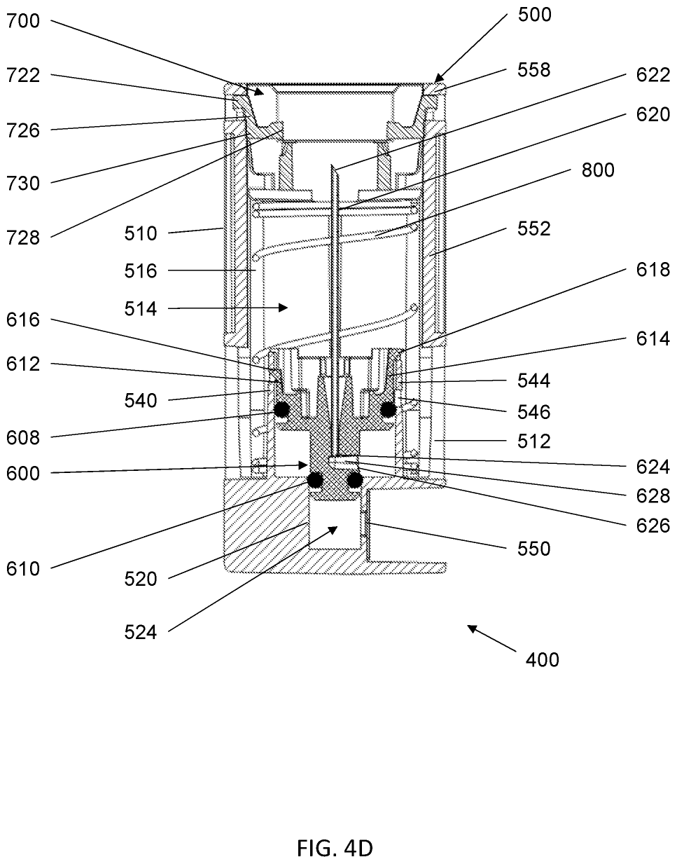

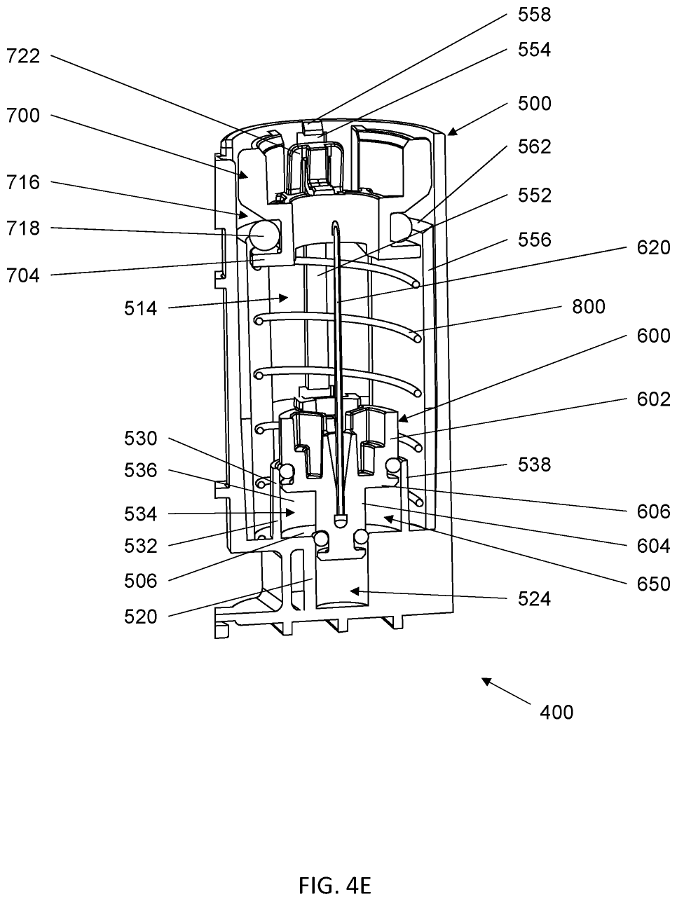

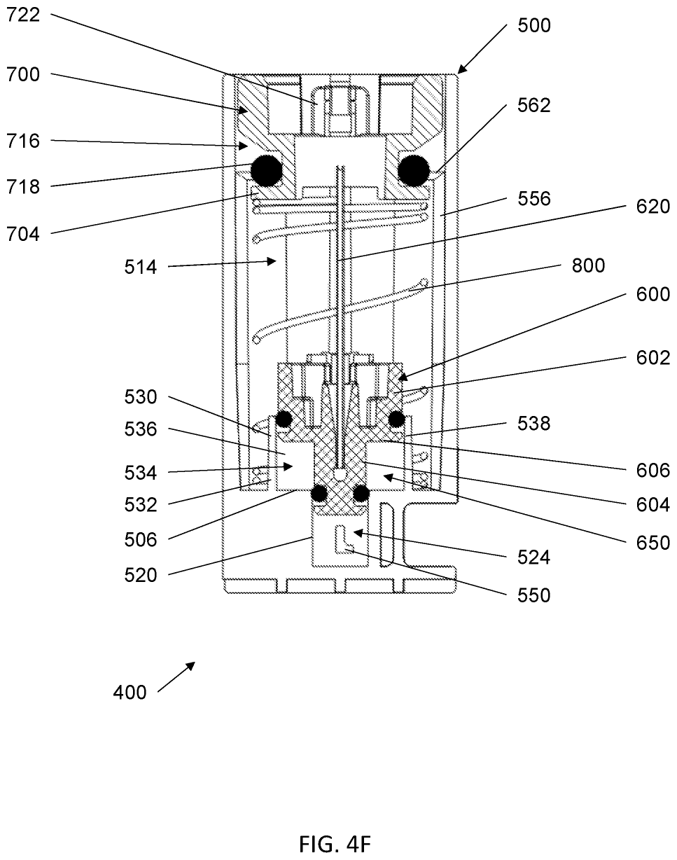

The liquid extraction device 200 comprises a safety mechanism 250 that is actuatable from a first safety mechanism configuration (shown in FIG. 1), in which the safety mechanism 250 conceals the needle 206, to a second safety mechanism configuration, in which the safety mechanism 250 reveals the needle 206. The safety mechanism 250 further comprises a blocking element (not shown in FIG. 1) that prevents actuation of the safety mechanism 250 from the first safety mechanism configuration to the second safety mechanism configuration when the liquid extraction device 200 is in a first orientation (e.g. horizontal), but permits actuation of the safety mechanism 250 from the first safety mechanism configuration to the second safety mechanism configuration when the liquid extraction device 200 is in a second orientation (e.g. vertical). The actuation of the safety mechanism 250 is described in more detail below with reference to the liquid extraction device 400 shown in FIGS. 4A to 12B.

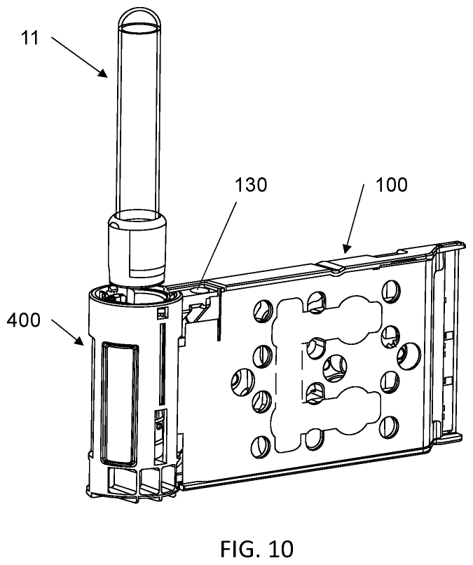

The cartridge 100 further comprises a sample adequacy control chamber 24 that provides a visual indication to a user that a sufficient amount of liquid has been extracted from the liquid storage container (e.g. blood collection tube). In particular, the sample adequacy control chamber 24 may provide a visual indication that a volume of liquid sufficient for a particular diagnostic test has been extracted. As shown, for example, in FIG. 10, the sample adequacy control chamber 24 is configured to provide the visual indication through an optically clear window 130 in a side wall of the cartridge 100 that is disposed upwards when the liquid extraction device 200 is in a vertical orientation (i.e. when the liquid extraction device 200 is used for extracting liquid from the liquid storage container).

The sample adequacy control chamber 24 forms part of a first flow path that is in fluidic communication with an inlet conduit 14 (which receives fluid extracted using the liquid extraction device 200). The cartridge 100 also includes a metering chamber 16 configured to store a specific volume of liquid. The first flow path includes the metering chamber 16, a connector conduit 22 providing a fluidic connection between the metering chamber 16 and the sample adequacy control chamber 24, the sample adequacy control chamber 24, and a vented waste chamber 44 in fluidic communication with the sample adequacy control chamber 24. The cartridge 100 further comprises a second flow path comprising an outlet conduit 43 extending from an outlet port in the metering chamber 16. The outlet conduit 43 allows liquid to be aspirated into the main chamber 104 of the cartridge 100. Alternative implementations may not include the metering chamber 16 or the connector conduit 22, in which case the outlet conduit 43 extends from an outlet port in a sample adequacy control chamber that is configured to meter a specific volume of liquid.

The second flow path (which includes the outlet conduit 43) provides a higher hydraulic resistance than the first flow path (which includes the sample adequacy control chamber 24, and optionally the metering chamber 16 and the outlet conduit 22). This means that the flow rate of liquid through the first flow path is higher than the flow rate through the second flow path. The higher flow rate through the first flow path means that liquid flows into the sample adequacy control chamber 24 to provide the visual indication that a sufficient volume of liquid has been received, without filling the outlet conduit 43.

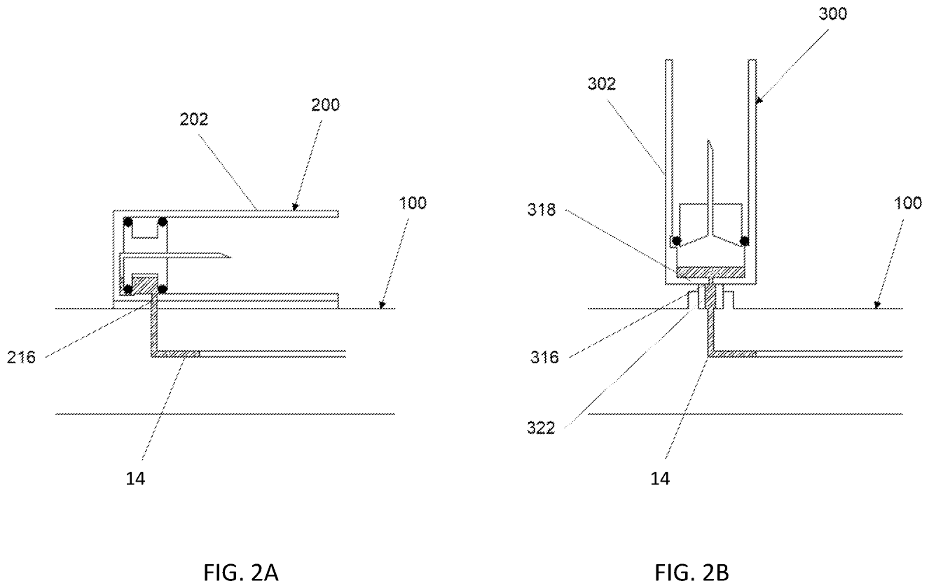

The outlet 216 of the liquid extraction device 200 shown in FIG. 1 is provided in a side wall of the cylinder 202. FIG. 2A shows the attachment between the first liquid extraction device 200 and the cartridge 100 in greater detail. Where the outlet 216 is provided in a side wall of the cylinder 202, the fluidic communication between the liquid extraction device 200 and the cartridge 100 may be provided by aligning the outlet 216 with a hole or via in the cartridge 100 that allows for the passage of fluid into the inlet conduit 14. The alignment of the outlet 216 with the hole or via may be provided by attaching the liquid extraction device 200 to the cartridge 100 using a layer of adhesive (e.g. a pressure-sensitive adhesive).

FIG. 2B shows an alternative attachment of a liquid extraction device to a cartridge, in which a second liquid extraction device 300 is attached to a cartridge (e.g. the cartridge 100). As with the liquid extraction device 200 shown in FIG. 2A, the liquid extraction device 300 comprises a cylinder 302 in which a pierceable liquid storage container, such as a blood collection tube, is received.

The liquid extraction device 300 also comprises a piston 304 that is moveable within the cylinder 302 from a first configuration to a second configuration. Attached to the piston 304 is a liquid storage container interface (e.g. needle 306) that provides a path for air to flow into the liquid storage container, and provides a path for liquid (e.g. blood) to flow out of the liquid storage container.

In contrast to the liquid extraction device 200 shown in FIG. 2A, however, the cylinder 302 comprises an outlet 316 that is provided in an end wall 318 of the cylinder 302. As shown in FIG. 2B, the outlet 316 in the cylinder 302 may be in fluidic communication with a connector 322 that protrudes from the base of the cylinder 302. The connector 322 allows the liquid extraction device 300 to be attached to the cartridge by a push-fit attachment (e.g. by inserting the connector 322 into a corresponding hole or aperture in the cartridge), or using a luer lock, or by any other suitable type of fluidic connector.

It will be appreciated that these attachment mechanisms are not specific to the locations of the outlet in the cylinder of the liquid extraction device. In particular, the liquid extraction device 300 shown in FIG. 2B may be attached to the cartridge using an adhesive, and the liquid extraction device 200 shown in FIG. 2A may comprise a connector protruding from the side wall of the cylinder 202, that allows for attachment to the cartridge 100 using a push-fit or luer lock mechanism, or any other suitable type of fluidic connector. The liquid extraction devices 200, 300 shown in FIGS. 2A and 2B may alternatively be integrated within the cartridge. For example, the cylinders 202, 302 may be moulded (or otherwise manufactured) together with the cartridge 100.

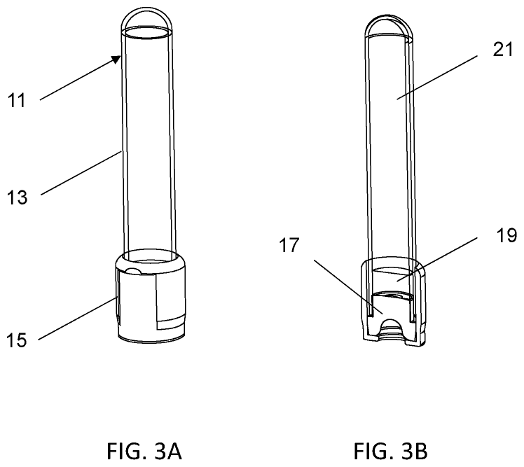

Various implementations of liquid extraction devices that may be used to extract a liquid sample (e.g. blood) from a pierceable liquid storage container (e.g. a blood collection tube) will now be described in greater detail with reference to FIGS. 3A to 17D.

An example of a blood collection tube that may be used with the implementations described herein is shown schematically in FIGS. 3A and 3B. As shown in FIG. 3A, the blood collection tube 11 comprises a tubular container 13 that is sealed using a cap 15. As best shown in FIG. 3B, the cap 15 comprises a septum 17 formed of a deformable material, such as rubber. The septum 17 is pierceable by a needle or cannula, thereby allowing an end of the needle or cannula to pass into an internal volume of the tubular container 13. When the needle or cannula is removed from the septum 17, the deformable material deforms to close the hole pierced by the needle or cannula, thereby re-sealing the container 13. When filled, the blood collection tube 11 contains a volume of liquid 19 (e.g. blood) and a headspace including a volume of gas 21. Examples of blood collection tubes 10 include Vacutainer (RTM) blood collection tubes manufactured by Becton, Dickinson and Company of Franklin Lakes, NJ, USA, along with vacuum blood collection tubes manufactured by Medtronic of Minneapolis, MN, USA, Vacuette (RTM) blood collection tubes manufactured by Greiner AG of Kremsmünster, Austria, and S-Monovette (RTM) blood collection tubes manufactured by Sarstedt of Nümbrecht, Germany.

FIG. 4A is an exploded view of a liquid extraction device 400 comprising a safety mechanism 700. As with the liquid extraction devices shown in FIGS. 1, 2A and 2B, the liquid extraction device 400 comprises a receptacle in the form of a cylinder 500, which is configured to receive a portion of a liquid storage container such as a blood collection tube (e.g. blood collection tube 11).

The liquid extraction device 400 further comprises an actuatable liquid extraction mechanism in the form of a piston 600 that is moveable within the cylinder 500 from a first liquid extraction mechanism configuration to a second liquid extraction mechanism configuration. The piston 600 comprises a liquid storage container interface, such as a blood collection tube interface, shown in FIG. 4A in the form of a needle 620. The needle 620 is configured to provide a fluidic connection to a volume of liquid within the liquid storage container when the liquid storage container is connected to the needle 620. The needle 620 is fixedly attached to the piston 600 such that the needle 620 moves within the cylinder 500 as the piston 600 is actuated from the first liquid extraction mechanism configuration to the second liquid extraction mechanism configuration.

The liquid extraction device 400 further comprises an actuatable safety mechanism 700 that is actuatable within the cylinder 500 from a first safety mechanism configuration to a second safety mechanism configuration. The safety mechanism 700 is configured to conceal the liquid storage container interface (i.e. needle 620) when the safety mechanism 700 is in the first safety mechanism configuration, and to reveal the liquid storage container interface when the safety mechanism 700 is in the second safety mechanism configuration.

The safety mechanism 700 comprises two spherical blocking elements 718. At least one of the blocking elements 718 prevents actuation of the safety mechanism 700 from the first safety mechanism configuration to the second safety mechanism configuration when the liquid extraction device 400 is in a first orientation (such as a horizontal orientation). The at least one of the blocking elements 718 also permits actuation of the safety mechanism 700 from the first safety mechanism configuration to the second safety mechanism configuration when the liquid extraction device 400 is in a second orientation (such as a vertical orientation).

The liquid extraction device 400 further comprises a resiliently deformable element, shown in FIG. 4A in the form of a spring 800. The spring 800 is deformed when the safety mechanism 700 is moved towards the piston 600 (i.e. when the safety mechanism 700 is actuated from the first safety mechanism configuration to the second safety mechanism configuration). The spring 800 is configured to bias the safety mechanism 700 away from the piston 600 when a force applied to compress the spring 800 is released. The spring 800 therefore biases the safety mechanism 700 away from the second safety mechanism configuration towards the first safety mechanism, thereby re-concealing the needle 620 following extraction of liquid from the liquid storage container.

FIG. 4B shows a top view of a liquid extraction device 400 comprising a safety mechanism 700, while FIGS. 4C and 4D show sectional views through line A-A in FIG. 4B, and FIGS. 4E and 4F show sectional views through line B-B in FIG. 4A.

As shown in FIGS. 4C and 4D, the cylinder 500 comprises a first cylinder portion 510 having a side wall 512 that defines a first cylindrical interior volume 514. The side wall 512 of the first cylinder portion 510 has an interior surface 516 that faces the first cylindrical interior volume 514, and an exterior surface 518 defining the exterior of the first cylinder portion 510.

The cylinder 500 further comprises a second cylinder portion 520 that defines a second cylindrical interior volume 524. The second cylindrical interior volume 524 extends from the first cylindrical interior volume 514. The cross-sectional area of the second cylindrical interior volume 524 is smaller than the cross-sectional area of the first cylindrical interior volume 514, such that the second cylindrical interior volume 524 is narrower than the first cylindrical interior volume 514.

An annular flange 506 is disposed within the cylinder 500 and joins the first cylindrical interior volume 514 to the second cylindrical interior volume 524. The annular flange 506 acts as an end wall for the first cylindrical interior volume 514.

As best shown in FIG. 4E and FIG. 4F, the cylinder 500 further comprises a third cylinder portion 530 that is disposed within the first cylindrical interior volume 514. The third cylinder portion 530 has a side wall 532 that defines a third cylindrical interior volume 534. The side wall 532 of the third cylinder portion 530 has an interior surface 536 that faces the third cylindrical interior volume 534, and an exterior surface 538 that faces the first cylindrical interior volume 514. The cross-sectional area of the third cylindrical interior volume 534 is in between the cross-sectional area of the first cylindrical interior volume 514 and the cross-sectional area of the second cylindrical interior volume 524.

The third cylinder portion 530 protrudes from the annular flange 506 in a direction opposite to the direction in which the second cylinder portion 520 extends. The diameter of the third cylinder portion 530 is smaller than the diameter of the first cylindrical interior volume 514, meaning that there is an annular gap between the exterior surface 538 of the side wall 532 of the third cylinder portion 530, and the interior surface 516 of the side wall 512 of the first cylinder portion 510. The height of the side wall 532 of the third cylinder portion 530 is smaller than the height of the side wall 512 of the first cylinder portion 510, such that the third cylinder portion 510 only protrudes part way into the first cylindrical interior volume 514.

Returning to FIG. 4C and FIG. 4D, it can be seen that the third cylinder portion 530 further comprises a first projection 540 extending from its side wall 532 into the first cylindrical interior volume 514. The first projection 540 is an extension of the side wall 532 and has the same thickness as the side wall 532, meaning that there is a gap between the first projection 540 and the interior surface 516 of the side wall 512 of the first cylinder portion 510. The first projection 540 includes an aperture, shown in FIG. 4C in the form of a first opening 542 extending through the thickness of the first projection 540.

Also shown in FIG. 4C and FIG. 4D is a second projection 544 that extends from the side wall 532 of the third cylinder portion 530 into the first cylindrical interior volume 514. The second projection 544 is also an extension of the side wall 532 and has the same thickness as the side wall 532, meaning that there is a gap between the second projection 544 and the interior surface 516. The second projection 544 extends from a point on the end of the side wall 532 that is diametrically opposed from the point from which the first projection 540 extends.

The second projection 544 includes two apertures, shown in FIG. 4C in the form of a second opening 546 extending through the thickness of the second projection 544 and a cutout 548 (or recess) in an upper surface of the second projection 544.

The first opening 542, second opening 546 and cutout 548 are provided at different heights, meaning that the distance from the annular flange 506 to the first opening 542, the distance from the annular flange 506 to the second opening 546, and the distance from the annular flange 506 to the cutout 548 are all different. Specifically, the distance from the annular flange 506 to the cutout 548 in the second projection 544 is greater than the distance from the annular flange 506 to the first opening 542 in the first projection 540, and the distance from the annular flange 506 to the first opening 542 in the first projection 540 is greater than the distance from the annular flange 506 to the second opening 546 in the second projection 544.

The cylinder 500 further comprises an outlet 550 that allows liquid extracted from a liquid storage container (e.g. a blood collection tube) using the liquid extraction device 400 to be removed from the liquid extraction device 400. The outlet 550 is in fluidic communication with the second cylinder portion 520 and extends through a side wall of the second cylinder portion 520 to provide a fluidic connection to the second cylindrical interior volume 524.

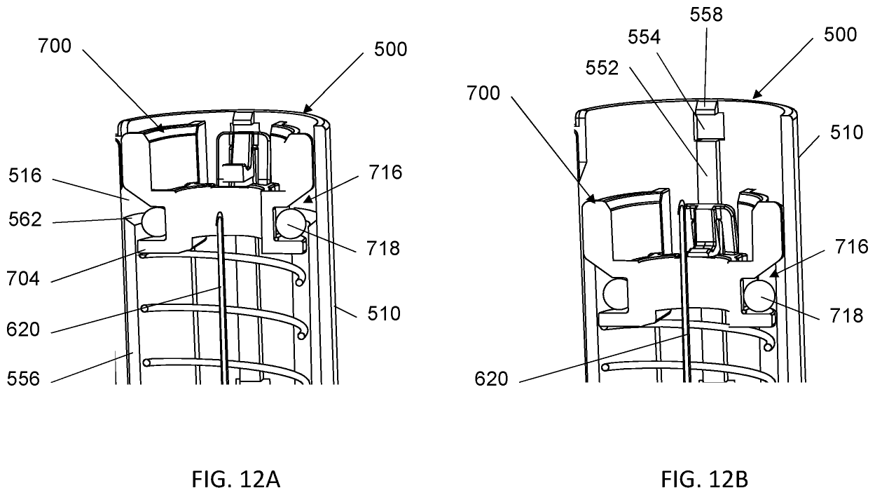

The first cylinder portion 510 includes two ribs 552 on the interior surface 516 of its side wall 512. The ribs 552 extend longitudinally along the interior surface 516. As best shown in FIGS. 4E and 12B, the first cylinder portion 510 further comprises two apertures, shown in the form of openings 554. Each rib 552 extends longitudinally between a point on the interior surface 516 that is approximately level with the top of the projections 540, 544, and a respective opening 554. Each opening 554 extends through the side wall 512 of the first cylinder portion 510. The openings 554 are provided at the end of the first cylinder portion 510 furthest from the annular flange 506 (i.e. at an upper end of the first cylinder portion 510 in the orientation shown in FIG. 4E). The first cylinder portion 510 further comprises two teeth 558, each of which extends radially inwards from the interior surface 516 at the upper end of the first cylinder portion 510. Each tooth 558 is aligned with a corresponding rib 552 and has the same circumferential thickness as a corresponding rib 552 (as best shown in FIG. 12B). In addition, the extent to which the teeth 558 project inwardly from the interior surface 516 is the same as the radial depth of the ribs 552 (as shown in FIG. 4C). Each tooth 558 includes an angled surface at the open end of the first cylinder portion 510.

As best shown in FIG. 4E, the side wall 512 of the first cylinder portion 510 also includes two restrictions 556 on its interior surface 516. Each restriction 556 extends longitudinally along a portion of the interior surface 516, between the annular flange 506 and a point towards the upper end of the first cylinder portion 510. The restrictions 556 do not extend longitudinally as far as the openings 554 in the first cylinder portion 510. Each restriction 556 extends around a portion of the circumference of the interior surface 516. The diameter of the first cylindrical interior volume 514 between the restrictions 556 is less than the diameter of the first cylindrical interior volume 514 between the portions of the side wall 512 along which the restrictions 556 do not extend. Each restriction 556 includes an angled end wall 562 at the end of the restriction 556 furthest from the annular flange 506. That is, each angled end wall 562 extends between the side wall 512 in the region above the restriction 556 and the interior face of the restriction 556. The first cylinder portion 510 also includes two grooves 560, each of which extends longitudinally along the centre of a respective restriction 556 (as best shown in FIG. 4C).

The ribs 552 extend longitudinally along the interior surface 516 in the regions of the interior surface 516 in which the restrictions 556 do not extend. Therefore, the restrictions 556 and ribs 552 do not overlap. As best shown in FIG. 4B, the two ribs 552 are diametrically opposed. Likewise, the two grooves 560 are also diametrically opposed. The interior surface 516 is symmetrical, such that each groove 560 is at 90 degrees to both ribs 552. As shown in FIG. 4B, the line A-A (through which the sections in FIGS. 4C and 4D are taken) extends through both ribs 552, while the line B-B (through which the sections in FIGS. 4E and 4F are taken) extends through both grooves 560.

As mentioned above with reference to FIG. 4A, the liquid extraction device 400 further comprises an actuatable liquid extraction mechanism in the form of a piston 600 that is moveable within the cylinder 500. Specifically, the piston 600 is actuatable from a first configuration within the cylinder 500 (i.e. a first liquid extraction mechanism configuration) to a second configuration within the cylinder 500 (i.e. a second liquid extraction mechanism configuration). In FIGS. 4C to 4F, the piston 600 is shown in the first configuration.

The piston 600 comprises a first cylindrical piston portion 602 having a diameter less than the diameter of the third cylindrical interior volume 534, such that the first cylindrical piston portion 602 is moveable within the third cylindrical interior volume 534.

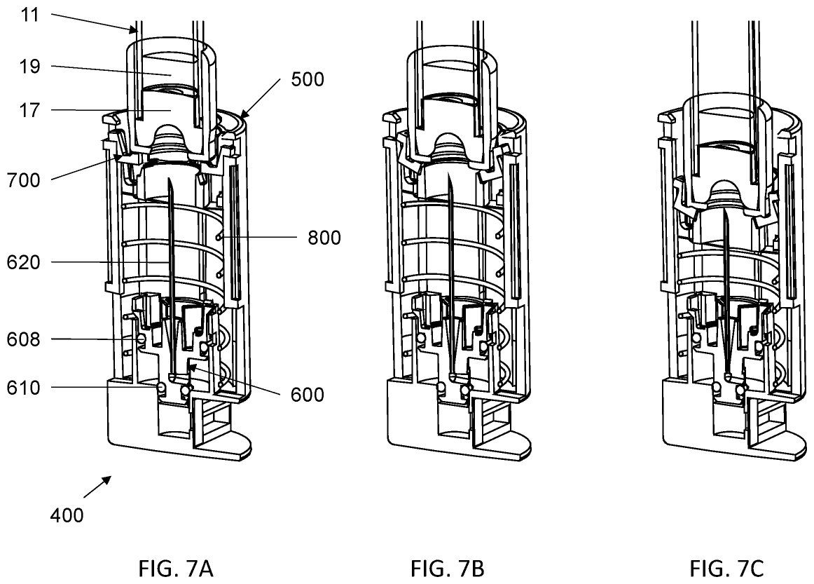

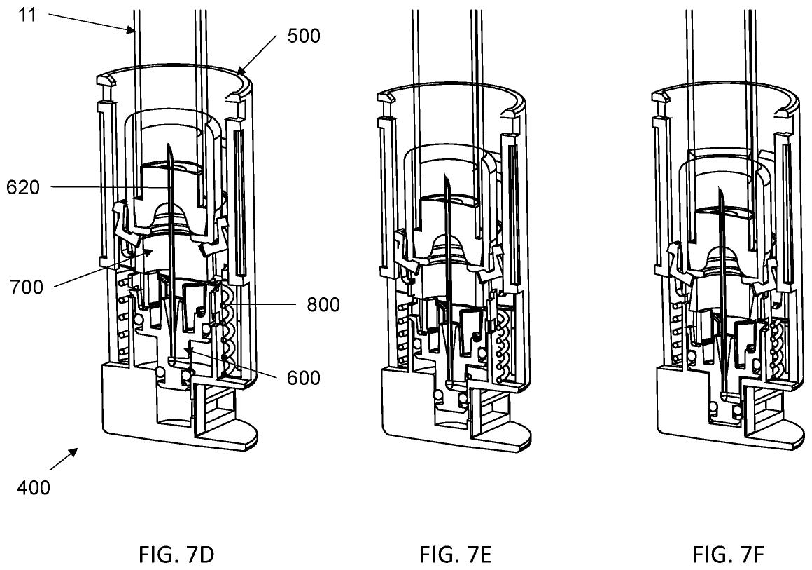

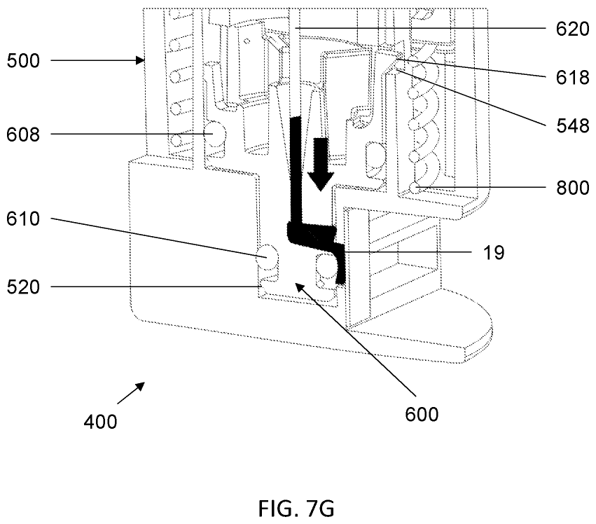

The piston 600 further comprises a second cylindrical piston portion 604 having a diameter less than the diameter of the second cylindrical interior volume 524, such that the second cylindrical piston portion 604 is moveable within the second cylindrical interior volume 524. This means that the second cylindrical piston portion 604 is narrower than the second cylindrical interior volume 524, thereby allowing air to flow in the annular gap between the second cylindrical piston portion 604 and the second cylinder portion 520 when the piston 600 is actuated to the position shown in FIGS. 7E and 7F.

The piston 600 further comprises an annular flange 606 that joins the first cylindrical piston portion 602 to the second cylindrical piston portion 604. The annular flange 606 of the piston 600 is configured to contact the annular flange 506 of the cylinder 500 when the piston is in the second configuration (i.e. as shown in FIG. 7F).

Returning to FIGS. 4C to 4D, it can be seen that the piston 600 comprises a first sealing element in the form of a first O-ring seal 608. The first O-ring seal 608 extends around the circumference of the first cylindrical piston portion 602 and is configured to provide a seal between the first cylindrical piston portion 602 and the interior surface 536 of the side wall 532 of the third cylinder portion 530.

The piston 600 further comprises a second sealing element in the form of a second O-ring seal 610. The second O-ring seal 610 extends around the circumference of the second cylindrical piston portion 604 and is configured to provide a seal between the second cylindrical piston portion 604 and the interior surface of the second cylinder portion 520. As an alternative to O-ring seals, the first and second sealing elements could be provided in the form of a moulded plastic seal (i.e. moulded together with the piston 600), or an over-moulded rubber seal.

The piston 600 and the cylinder 500 cooperate to define a chamber 650 between the piston 600 and the walls of the cylinder 500. Specifically, the chamber 650 is defined by the annular flange 506 within the cylinder 500, the interior surface 536 of the third cylinder portion 530, the interior surface of the second cylinder portion 520, the second cylindrical piston portion 604, and the annular flange 606 of the piston 600. The chamber 650 is sealed by the first and second O-ring seals 610, 612, which prevent air flow out of the chamber 650 until the piston is actuated to the second configuration (i.e. as shown in FIG. 7F).

The first cylindrical piston portion 602 comprises a first engagement mechanism that is configured to prevent actuation of the piston 600 from the first liquid extraction mechanism configuration in a direction opposite to the direction of actuation from the first liquid extraction mechanism configuration to the second liquid extraction mechanism configuration. The first engagement mechanism is shown in FIGS. 4C and 4D in the form of a first resiliently deformable clip 612 that is configured to engage the first opening 542 in the first projection 540, when the piston 600 is in the first configuration (i.e. as shown in FIG. 4C).

The first resiliently deformable clip 612 has a protrusion 616 that extends into the first opening 542. The protrusion 616 includes an angled lower surface that allows the protrusion 616 to be pushed out of the first opening 542 when sufficient force is applied to the piston 600 in the direction of the annular flange 506 (i.e. a downward force in the orientation shown in FIG. 4C). The protrusion 616 also includes an upper contact surface that is perpendicular to the axis of movement of the piston 600. The upper contact surface engages the first opening 542 so as to prevent movement of the piston 600 away from the annular flange 506 when the protrusion extends into the first opening 542 (i.e. when the piston 600 is in the first configuration).

The first cylindrical piston portion 602 also comprises a second engagement mechanism that is configured to retain the piston 600 in the second liquid extraction mechanism configuration once the piston 600 has been actuated to the second liquid extraction mechanism configuration. The second engagement mechanism is provided in the form of a second resiliently deformable clip 614 that is configured to engage the cutout 548 in the second projection 544, when the piston 600 is in the first configuration (i.e. as shown in FIG. 4C). The second resiliently deformable clip 614 is further configured to engage the second opening 546 in the second projection 544, when the piston 600 is in the second configuration (i.e. as shown in FIG. 7F).

The second resiliently deformable clip 614 further includes a protrusion 618 that extends into the cutout 648 when the piston 600 is in the first configuration, and extends into the second opening 646 when the piston 600 is in the second configuration. The protrusion 618 has the same construction as the protrusion 616 of the first resiliently deformable clip 612. Specifically, the protrusion 618 includes an angled lower surface that allows the protrusion 618 to be pushed out of the cutout 648 when sufficient force is applied to the piston 600 in the direction of the annular flange 606. The protrusion 618 also includes an upper contact surface that is perpendicular to the axis of movement of the piston 600. The upper contact surface engages the second opening 546 so as to prevent movement of the piston 600 away from the annular flange 506 when the protrusion extends into the second opening 546 (i.e. when the piston 600 is in the second configuration).

Therefore, in the orientation shown in FIG. 4B, the first engagement mechanism (i.e. the first resiliently deformable clip 612) prevents upward movement of the piston 600 from the first configuration of the piston 600, but permits downward movement of the piston 600 from the first configuration to the second configuration. This prevents the piston 600 (and needle 620) from being removed from the cylinder 500 before actuation of the piston 600, thereby protecting the user. Likewise, the second engagement mechanism (i.e. the second resiliently deformable clip 614) permits downward movement of the piston 600 from the first configuration to the second configuration, but prevents upward movement of the piston 600 once the piston 600 is in the second configuration. This prevents the piston 600 (and needle 620) from being removed from the cylinder 500 after actuation of the piston 600, thereby protecting the user.

As shown in FIGS. 4C and 4D, each resiliently deformable clip 612, 614 may be provided in the form of a living hinge extending from the first cylindrical piston portion 602.

As described with reference to FIG. 4A, the piston 600 further comprises a liquid storage container interface (i.e. needle 620), which is fixedly attached to the piston 600 such that the needle 620 moves within the cylinder 500 as the piston 600 is actuated from the first configuration to the second configuration. The needle 620 extends from the first cylindrical piston portion 602 in a direction away from the annular flange 506 (i.e. upwardly in the orientation shown in FIGS. 4C to 4F). The needle 620 has two ends: a first end 622 (or tip) that protrudes from the piston 600, and a second end 624 that is fixed within the piston 600. The first end 622 is configured to pierce the septum 17 of the blood collection tube 11, thereby providing a fluidic connection to the volume of liquid 19 within the blood collection tube 11, and providing attachment of the needle 620 to the blood collection tube 11.

The second cylindrical piston portion 604 comprises a liquid extraction outlet 626 that allows liquid extracted from the liquid storage container to be removed from the piston 600. The liquid extraction outlet 626 is provided in a side wall of the second cylindrical piston portion 604. The second cylindrical piston portion 604 further comprises an outlet channel 628 providing fluidic communication between the second end 624 of the needle 620 and the liquid extraction outlet 626. When the piston 600 is in the second configuration (i.e. as shown in FIG. 7F), the liquid extraction outlet 626 is aligned with the outlet 550 in the cylinder 500.

Returning to FIGS. 4B to 4F, it can be seen that the liquid extraction device 400 further comprises an actuatable safety mechanism 700 that is actuatable from a first safety mechanism configuration, shown in FIG. 4C, to a second safety mechanism configuration, shown in FIG. 7D. The safety mechanism 700 is configured to conceal the needle 620 when the safety mechanism 700 is in its first configuration, and to reveal the needle 620 when the safety mechanism 700 is in its second configuration.

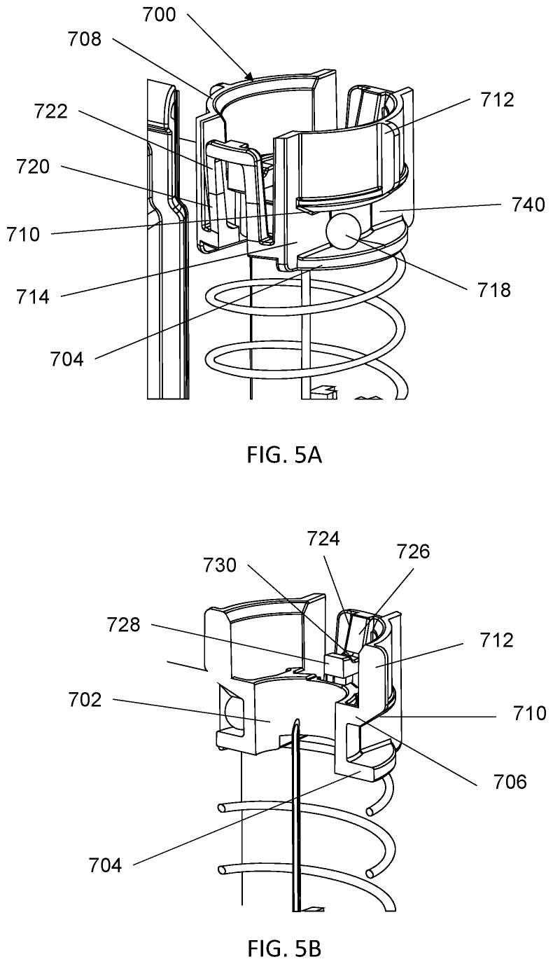

The safety mechanism 700 is shown in more detail in FIGS. 5A and 5B. FIG. 5A is a cutaway view of the liquid extraction device 400, in which the cylinder 500 has been removed in order to show the safety mechanism 700. FIG. 5B is a sectional view through the safety mechanism 700 shown in FIG. 7A.

The safety mechanism 700 comprises an aperture in the form of a central cylindrical portion 702 through which the needle 620 (in particular, the tip 622 of the needle 620) extends when the safety mechanism 700 is in the second configuration shown in FIG. 7D.

As best shown in FIGS. 4E, 4F and 5B, two lower flange sections 704 extend from the base of the central cylinder portion 702 (i.e. from the end of the central cylinder portion 702 closest to the annular flange 506). Each lower flange section 704 extends radially from the base of the central cylinder portion 702 around a portion of the circumference of the central cylinder portion 702, such that each lower flange section 704 forms an annulus sector. The distance between the radial extents of the lower flange sections 704 is less than the distance between the restrictions 556, meaning that the lower flange sections 704 pass within the restrictions 556 as the safety mechanism 700 is actuated from the first configuration to the second configuration.

Two upper flange sections 706 extend from the top of the central cylinder portion 702 (i.e. from the end of the central cylinder portion 702 furthest from the annular flange 506). The upper flange sections 706 extend radially from the top of the central cylinder portion 702 around the same portion of the circumference of the central cylinder portion 702 around which the lower flange sections 704 extend. The distance between the radial extents of the upper flange sections 706 is less than the distance between the restrictions 556, meaning that the upper flange sections 706 also pass within the restrictions 556 as the safety mechanism 700 is actuated from the first configuration to the second configuration.

As best shown in FIG. 5A, an arc-shaped section 708 extends longitudinally from each upper flange section 706. Each arc-shaped section 708 extends away from a lower flange section 704 (i.e. upwardly in the orientation shown in FIG. 5A). Each arc-shaped section 708 extends around the same circumferential extent as its corresponding upper flange section 706 from which it extends. Each arc-shaped section 708 has an interior surface with a radius that is greater than the radius of the cap 15 of the blood collection tube 11, meaning that the blood collection tube 11 can be inserted between the arc-shaped sections 708, as shown in FIG. 7A.

The safety mechanism 700 further comprises an angled shoulder 710 provided at the join between each upper flange section 706 and its corresponding arc-shaped section 708. The angled shoulders 710 extend around the same circumferential extent as the corresponding upper flange sections 706 and arc-shaped sections 708.

The lower flange sections 704, upper flange sections 706, arc-shaped sections 708 and angled shoulders 710 each extend around the same circumferential extent as the restrictions 556 extending from the interior surface 516 of the side wall 512 of the first cylinder portion 510.

As best shown in FIGS. 5A and 5B, each arc-shaped section 708 includes a central rib 712 that projects radially outwards from the arc-shaped section 708. Each central rib 712 extends from the middle of the corresponding arc-shaped section 708 and is configured to be slidably received within a corresponding longitudinal groove 560 extending along a corresponding restriction 556. The central ribs 712 align the safety mechanism 700 in the correct orientation within the cylinder 500 by preventing rotation of the safety mechanism 700 within the cylinder 500.

As best shown in FIG. 5A, the safety mechanism 700 further comprises four end ribs 714 projecting outwards from the central cylinder portion 702. The end ribs 714 are provided at both ends of each arc-shaped section 708. As shown in FIG. 5A, each end rib 714 defines a wall that joins together one end of the arc-shaped section 708, angled shoulder 710, lower flange section 704 and upper flange section 706. In other words, each arc-shaped section 708, angled shoulder 710, lower flange section 704 and upper flange section 706 extends circumferentially between two of the ribs 714 that project outwards from the central cylinder portion 702.

As shown in FIGS. 4E and 4F, the safety mechanism 700 and cylinder 500 together define two arcuate channels 716 between the safety mechanism 700 and the interior surface 516 of the side wall 512 of the first cylinder portion 510. Specifically, the inner radial extent of each actuate channel 716 is defined by the central cylinder portion 702, the outer radial extent of each arcuate channel 716 is defined by the interior surface 516, the circumferential extent of each arcuate channel 716 is defined by the end ribs 714, the lower longitudinal extent of each arcuate channel 716 is defined by a lower flange section 704, and the upper longitudinal extent of each arcuate channel 716 is defined by an upper flange section 706 and an angled shoulder 710.

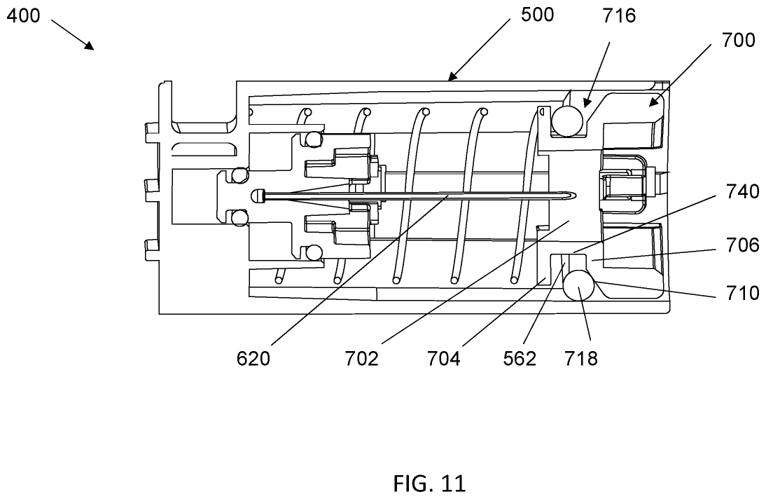

The spherical blocking elements 718 of the safety mechanism 700 are each provided in a respective arcuate channel 716. The spherical blocking elements 718 may be, for example, ball bearings. As described in more detail below with reference to FIGS. 11, 12A and 12B, at least one of the spherical blocking elements 718 is configured to cooperate with a corresponding arcuate channel 716 and angled end wall 558 of a restriction 556 so as to prevent movement of the safety mechanism 700 from the first configuration to the second configuration when the liquid extraction device 400 is in a first orientation (FIG. 11), and to allow movement of the safety mechanism 700 from the first configuration to the second configuration when the liquid extraction device 400 in a second orientation (FIGS. 12A and 12B).

Together, the central cylinder portion 702, end ribs 714, lower flange sections 706, upper flange sections 708 and angled shoulders 710 define two arcuate recesses 740. As shown in FIGS. 4E and 4F, each recess 740 is configured to house a respective spherical blocking element 718, such that the blocking element 718 does not protrude from the recess 740 when the blocking element 718 is fully disposed within the recess 740. In other words, the blocking element 718 does not engage the angled end wall 558 when fully disposed within the recess 740, thereby allowing movement of the safety mechanism 700 from the first configuration to the second configuration.

As best shown in FIG. 5A, the safety mechanism 700 further comprises a release mechanism in the form of two resiliently deformable clips 720. Each resiliently deformable clip 720 is attached to two of the end ribs 714. The attachment of each clip 720 to the end ribs 714 provides a living hinge that allows the clip 720 to be resiliently deformed. The resiliently deformable clips 720 are disposed between the end ribs 714 in the regions in which the lower flange sections 704, upper flange sections 706, arc-shaped sections 708 and angled shoulders 710 do not extend. This means that the resiliently deformable clips 720 are free to pivot inwardly towards the central cylinder portion 702.

As best shown in FIGS. 4E and 5A, each resiliently deformable clip 720 comprises a U-shaped section 722 that extends upwardly (i.e. away from the lower flange sections 704 in a longitudinal direction) from the points of attachment to the end ribs 714. When not deformed (i.e. as shown in FIG. 5A), the U-shaped sections 722 are biased in an outwardly radial direction. The release mechanism is configured to engage a portion of the cylinder 500 when the safety mechanism 700 is in the first configuration. Specifically, each U-shaped section 722 is configured to clip over the end of a respective rib 552 within the first cylinder portion 502 (as shown in FIGS. 4C and 4E). When the U-shaped sections 722 are clipped over the ends of the ribs 552, the clips 720 prevent movement of the safety mechanism 700 from the first configuration to the second configuration. Optionally, the U-shaped sections 722 may protrude into the openings 554 when the safety mechanism 700 is in the first configuration.

The angled surfaces of the teeth 558 at the open end of the first cylinder portion 502 push the resiliently deformable clips 720 inwards when the safety mechanism 700 is inserted into the cylinder 500 during assembly of the liquid extraction device 400. The teeth 558 also act to retain the safety mechanism 700 in place by preventing upwards movement of the safety mechanism 700 out of the first configuration. In particular, the clips 720 are retained in the gaps between the teeth 558 and the ends of the ribs 552. Accordingly, when the clips 720 are retained in the gaps between the teeth 558 and the ends of the ribs 552, the safety mechanism 700 is retained in the first configuration.

As best shown in FIGS. 4C and 5B, each resiliently deformable clip 720 further comprises an L-shaped lever 724 that extends inwardly from a corresponding U-shaped section 722. Specifically, each lever 724 comprises a longitudinal portion 726 that extends longitudinally from the U-shaped section 722 towards the upper extent of the central cylinder portion 702. The longitudinal portion 726 is configured to contact the rib 552 over which the U-shaped portion 722 is clipped.

Each lever 724 further comprises a radial portion 728 extending radially inwards from the end of the longitudinal portion 726. The radial portions 728 of the levers 724 extend sufficiently far inwards so that they are contacted by the cap 15 of a blood collection tube 11. Consequently, when a downward force is applied to the blood collection tube 11, the cap 15 simultaneously applies a downward force to each radial portion 728.

The longitudinal portion 726 of each lever 724 is joined to the radial portion 728 at an elbow 730. The elbow contacts the rib 552 over which the U-shaped portion 722 is clipped, and is configured to provide a pivot point against the rib 552 when a downward force is applied to the corresponding radial portion 728.

When the cap 15 of the blood collection tube 11 is pressed against the radial portions 728 of the levers 724, the force applied to each radial portion 728 of the lever 724 causes the lever 724 to pivot about the contact point between the elbow 730 and the rib 552 over which the clip 720 is attached. The pivoting of the lever 724 causes the clip 720 to hinge inwardly about its attachments to the end ribs 714 (as shown, for example, in FIG. 7B). This means that the U-shaped portions 722 are withdrawn from the gap between the ends of the ribs 552 and the teeth 558, thereby allowing the safety mechanism 700 to be displaced within the cylinder 500 from the first configuration to the second configuration. When the clips 720 are pivoted inwards by the cap 15 of the blood collection tube 11, there is a clearance between the cap 15 and the upper end of the central cylinder portion 702.

Accordingly, the safety mechanism 700 is configured to be unclipped by the application of simultaneous forces to the resiliently deformable clips 720 (specifically, to the radial portions 728 of the levers 724 of the clips 720). The forces may be simultaneously applied to the radial portions 728 by, for example, by application of an annular force profile, such as that applied by a cap 15 of a blood collection tube 11.

The resiliently deformable element (spring 800) of the liquid extraction device 400 is disposed between the annular flange 506 of the cylinder 500 and the lower flange sections 704 of the safety mechanism 700, as shown in FIGS. 4C to 4F. The spring 800 biases the safety mechanism 700 upwards such that the U-shaped sections 722 of the clips 720 contact the underside of the teeth 558 when the safety mechanism 700 is in the first configuration (as shown in FIG. 4C). The spring 800 is configured to be compressed when the safety mechanism 700 is actuated from the first configuration to the second configuration by application of a downwards force on the safety mechanism 700. When the applied force is removed (or reduced below the force exerted by on the safety mechanism 700 by the compressed spring 800), the spring 800 applies a force to actuate the safety mechanism 700 from the second configuration towards the first configuration, thereby returning the safety mechanism 700 to the second configuration to re-conceal the needle 620.

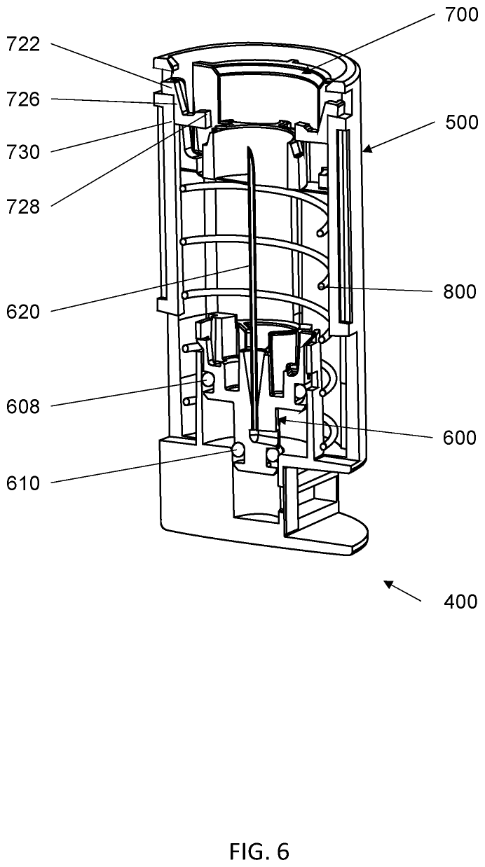

The operation of the safety mechanism 700 will now be described with reference to FIGS. 6 to 12B.

FIG. 6 shows the position of the safety mechanism 700 when a force is applied to the top of the arc-shaped sections 708, the top of the end ribs 714, or to the top of the upper cylinder portion 702. For example, FIG. 6 shows the position of the safety mechanism 700 when a force is applied to the safety mechanism 700 by a user's finger.

When a force is applied to one or more of these elements, the radial portions 728 of the L-shaped levers 724 are not displaced, meaning that the clips 720 are retained in the gaps between the ends of the ribs 552 and the teeth 558. As shown in FIG. 6, the applied force causes the U-shaped portions 722 to abut the ends of the ribs 552. However, the abutment of the U-shaped portions 722 against the ends of the ribs 552 prevents further downward movement of the safety mechanism 700. Accordingly, the safety mechanism 700 is prevented from moving out of the first configuration and the needle 620 remains concealed within the first cylinder portion 510.

Specifically, when a force is applied in this manner, the effective pivot point of each clip 720 against the surface of the corresponding rib 552 is at the base of the U-shaped portion 722, which is almost coincident with the attachment point of the clip 720 to the end ribs 714. The location of this effective pivot point prevents the clips 720 from hinging inwardly about their point of attachment to the end ribs 714.

FIGS. 7A to 7G show the actuation of the safety mechanism 700 and the piston 600 when a force is applied to the resiliently deformable clips 720 by a cap 15 of a blood collection tube 11.

FIG. 7A shows the cap 15 of a blood collection tube 11 in contact with the resiliently deformable clips 720. Specifically, the cap 15 fits between the two arc-shaped sections 708 and contacts the radial portions 728 of the L-shaped levers 724 of the clips 720. When a force is applied to the blood collection tube 11 in the direction of the needle 620 (i.e. a downwards force when the liquid extraction device 400 is in the orientation shown in FIG. 7A), the U-shaped portions 722 are forced downwards to abut the ends of the ribs 552, as shown in FIG. 7A.

Further application of the force to the blood collection tube 11 applies a downward force to the radial portions 728 of the levers 724, which causes each lever 724 to pivot about the contact point between the elbow 730 of the lever 724 and the rib 552, as shown in FIG. 7B. The pivoting of the lever 724 causes the resiliently deformable clips 720 to hinge inwardly about their attachments to the end ribs 712, which draws the U-shaped portions 722 out of engagement with the ends of the ribs 552. This unclips the safety mechanism 700, allowing it to be displaced downwards. Once the U-shaped portions 722 are disengaged from the ends of the ribs 552, the safety mechanism 700 may be displaced downwards by application of the force to the blood collection tube 11 (which transfers the force to the safety mechanism 700 via the clips 720).

Further application of the force to the blood collection tube 11 applies a downward force to the safety mechanism 700. This pushes the safety mechanism 700 downwards so that the needle 620 extends through the central cylinder portion 702, as shown in FIG. 7C, thereby revealing the needle 620. Once the needle 620 passes through the central cylinder portion 702, it protrudes from the safety mechanism 700 and can pierce the septum 17 of the blood collection tube 11. The applied downward force also compresses the spring 800.

Continued application of the force to the blood collection tube 11 actuates the safety mechanism 700 to its second configuration, in which safety mechanism 700 contacts the piston 600. Specifically, the base of the central cylinder portion 702 is forced into contact with the top of the first cylindrical piston portion 602, and the spring 800 is further compressed, as shown in FIG. 7D. In this position, the needle 620 has been forced through the septum 17 and into fluidic communication with the volume of liquid 19 within the blood collection tube 11.

Once in the second configuration, the safety mechanism 700 is configured to actuate the piston 600. Specifically, the safety mechanism 700 transfers the force applied by the user on the blood collection tube 11 to the piston 600. Optionally, the safety mechanism 700 may be configured to unclip the piston 600 (e.g. if the piston 600 includes resiliently deformable clips that are similar to the resiliently deformable clips 720 of the safety mechanism 700).

When the piston 600 is in the position shown in FIG. 7D (i.e. the first configuration of the piston 600), the second resiliently deformable clip 614 is in engagement with the cutout 548 in the second projection 544. The engagement of the second resiliently deformable clip 614 with the cutout 548 prevents downward movement of the piston 600 before the needle 620 has been fully inserted through the septum 17. In order to prevent downward movement of the piston 600 before proper insertion of the needle 620, the force required to displace the second resiliently deformable clip 614 from the cutout 548 is greater than the force required to insert the needle 620 through the septum 17. To achieve this, the second resiliently deformable clip 614 may, for example, be formed of a material with sufficient stiffness, in order to resist deformation until a higher force is applied.

When the piston 600 is in the position shown in FIG. 7D, upwards movement of the piston 600 is prevented by the engagement of the first resiliently deformable clip 612 with the first opening 542 in the first projection 540. This prevents the piston 600 from being pulled out of the third cylinder portion 530 in the event that a user applies an upwards force to the blood collection tube 11 (for example, before the needle 620 has been fully inserted through the septum 17).

Continued application of a downward force on the blood collection tube 11 applies a downward force to the safety mechanism 700, which in turn applies a downward force to the piston 600, and further compresses the spring 800. As shown in FIG. 7E, this downward force disengages the second resiliently deformable clip 614 from the cutout 548 in the second projection 544 and disengages the first resiliently deformable clip 612 from the first opening 542 in the first projection 540, thereby allowing the piston 600 to be actuated in the direction of the annular flange 506 (i.e. downwards in the orientation shown in FIG. 7E).

The downwards movement of the piston 600 reduces the volume of the chamber 650 defined by the piston 600 and the cylinder 500. As shown in FIG. 7E, the volume of the chamber 650 has been reduced, but air flow out of the chamber is prevented by the first and second O-ring seals 610, 612. The reduction in volume of the chamber 650 increases the pressure of the air within the chamber 650, which forces air into the blood collection tube 11 via the liquid extraction outlet 626, outlet channel 628 and needle 620, thereby increasing the pressure of the volume of gas 21 within the blood collection tube 11.

Further downward movement of the piston 600 by continued application of a downward force via the safety mechanism 700 results in a further increase in pressure of the air within the chamber 650 and the blood collection tube 11, until the piston 600 reaches the second configuration, shown in FIG. 7F. In this position, the spring 800 is further compressed. Once the piston 600 is in the second configuration, the second O-ring seal 612 is aligned with the outlet 550, which compromises the sealing provided by the second O-ring seal 612, thereby bringing the chamber 650 (and the liquid extraction outlet 626) into fluidic communication with the outlet 550. This allows any air remaining in the chamber 650 (which now has a small volume) to escape via the outlet 550. As the outlet 550 is at atmospheric pressure, the fluidic communication between the outlet 550 and the liquid extraction outlet 626 in the piston 600 means that the liquid extraction outlet 626 is also at atmospheric pressure. At this point, there is a pressure difference between the volume of gas 21 within the blood collection tube 11 and the liquid extraction outlet 626. Specifically, the pressure of the volume of gas 21 within the blood collection tube 11 is higher than the pressure at the liquid extraction outlet 626 (which is at atmospheric pressure). The difference in pressure between the volume of gas 21 in the blood collection tube 11 and the liquid extraction outlet 626 forces liquid through the needle 620, out of the liquid extraction outlet 626 via the outlet channel 628, and out of the outlet 550 from the cylinder 500, as shown in FIG. 7G.

As shown in FIGS. 7F and 7G, the second resiliently deformable clip 614 engages the second opening 546 in the second projection 544, when the piston 600 is actuated to the second configuration. The engagement of the second resiliently deformable clip 614 with the second opening 546 provides an audible click that informs the user that the piston 600 has been actuated to the second configuration. Once the user hears the audible click of the engagement between the second resiliently deformable clip 614 and the second opening 546, the user is aware that liquid is being extracted from the blood collection tube 11. The engagement of the second resiliently deformable clip 614 and the second opening 546 also prevents upward movement of the piston 600 out of the second configuration. This means that, as long as there is a fluidic connection between the needle 620 and the volume of liquid 19 within the blood collection tube 11, liquid will continue to be extracted even if there is a temporary reduction or release of the force applied by the user.

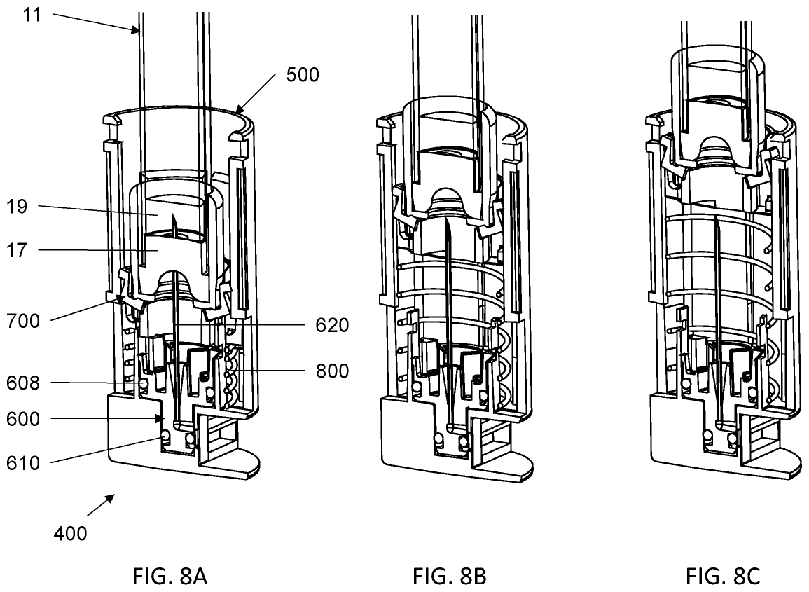

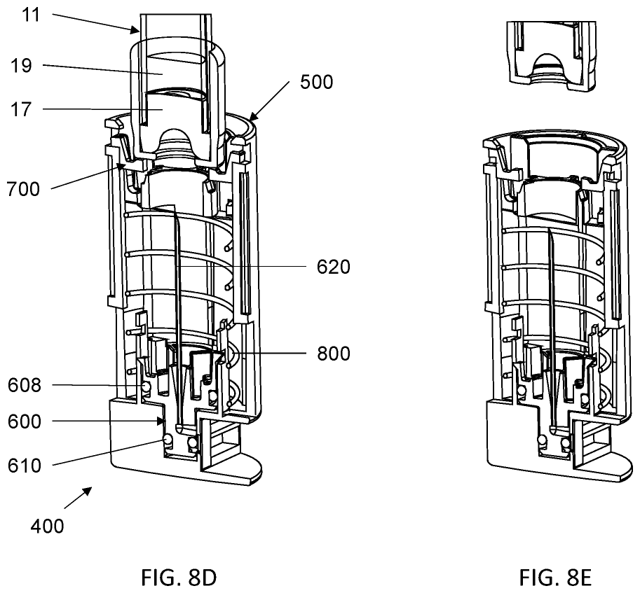

FIGS. 8A to 8E show the actuation of the safety mechanism 700 when the force applied by the user is released.

FIG. 8A shows the piston 600 in its second configuration (i.e. in the same position as FIG. 7F). When the force applied by the user is released, the compressed spring 800 exerts a force on the safety mechanism 700, thereby forcing the safety mechanism 700 away from the annular flange 506. As shown in FIG. 8B, the force exerted on the safety mechanism 700 pushes the safety mechanism 700 out of contact with the piston 600 and draws the needle 620 out of fluidic connection with the volume of liquid 19, and out of the septum 17. As discussed with respect to FIGS. 7F and 7G, the piston 600 is retained in its first configuration by the engagement of the second engagement mechanism (i.e. the second resiliently deformable clip 614 and the second opening 546 in the second projection 544).

The force exerted by the spring 800 on the safety mechanism 700 continues to force the safety mechanism 700 away from the annular flange 506, until the safety mechanism 700 reaches the position shown in FIG. 8C. In this position, the needle 620 no longer protrudes through the aperture in the safety mechanism 700 (i.e. the central cylinder portion 702), meaning that the needle 620 is concealed by the safety mechanism 700. At this point, the U-shaped portions 722 of the resiliently deformable clips 720 are displaced to the ends of the ribs 552. This causes each L-shaped lever 724 to pivot about its elbow 730, which causes the U-shaped portions 722 to clip over the ends of the ribs 552, thereby returning the safety mechanism 700 to its first configuration, as shown in FIG. 8D. The blood collection tube 11 can then be removed from engagement with the radial portions 728 of the levers 724 of the resiliently deformable clips 720.

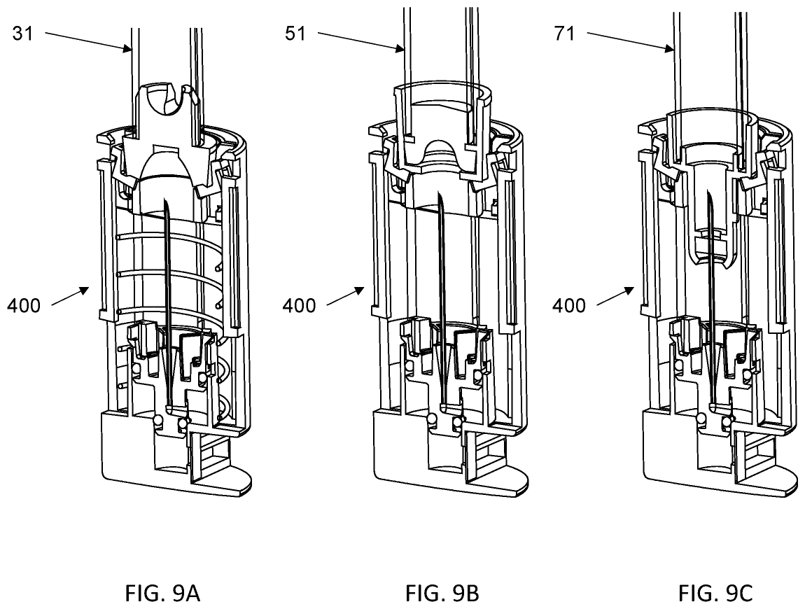

The operation of the liquid extraction device 400 has been described with reference to extracting liquid from a Vacutainer (RTM) as manufactured by Becton, Dickinson and Company of Franklin Lakes, NJ, USA (indicated in FIGS. 7A to 8D as blood collection tube 11). However, as shown in FIGS. 9A to 9C, the liquid extraction device 400 can also be used to extract liquid from other blood collection tubes.

In particular, FIG. 9A shows that the liquid extraction device 400 is compatible with a vacuum blood collection tube 31 manufactured by Medtronic of Minneapolis, MN, USA. FIG. 9B shows that the liquid extraction device 400 is compatible with a Vacuette (RTM) blood collection tube 51 manufactured by Greiner AG of Kremsmünster, Austria. FIG. 9C shows that the liquid extraction device 400 is compatible with a S-Monovette (RTM) blood collection tube 71 manufactured by Sarstedt of Nümbrecht, Germany. As shown in FIG. 9C, the septum of the Sarstedt blood collection tube 71 is pierced prior to engagement of the cap of the blood collection tube 71 with the levers 724 of the safety mechanism 700. In addition, the central cylinder portion 702 defines an aperture that is configured to receive the protruding portion of the cap of the blood collection tube 71.

To ensure compatibility with these different types of blood collection tubes, the radial portions 728 of the levers 724 are dimensioned so that they are displaced by the cap of each type of blood collection tube. It will be appreciated that the size of the cylinder 500 and safety mechanism 700 may be adjusted in order to cater for different sizes of blood collection tubes (e.g. containing different sample types).

The safety mechanism 700 also ensures that the blood collection tube 11 is inserted into the liquid extraction device 400 in the correct orientation. As described above, the needle 620 must provide a fluidic connection to the volume of liquid 19 within the blood collection tube 11, in order to extract liquid from the blood collection tube 11. It will be appreciated that if the blood collection tube 11 has a high liquid fill level, then the needle 620 would provide a fluidic connection to the volume of liquid 19 even if the liquid extraction device 400 was in a horizontal orientation.

However, to ensure that the fluidic connection is provided for lower fill volumes, the safety mechanism 700 can only be actuated from its first configuration to its second configuration when the liquid extraction device 400 is in a vertical (or close to vertical) orientation (i.e. when the needle 620 is pointing upwards), as shown in FIG. 10. FIG. 10 shows the blood collection tube 11 being inserted into the liquid extraction device 400 when the liquid extraction device 400 is in a vertical orientation. In this example, the liquid extraction device 400 is integral with the cartridge 100. In addition, the wall through which the sample adequacy control chamber is viewable is shown. The sample adequacy control chamber may, for example, be viewable through an optically clear window 130 in the wall. When a user determines the presence of a volume of liquid within the sample adequacy control chamber, they are aware that the application of a downward force to the blood collection tube 11 can be ceased.

FIG. 11 shows how the safety mechanism 700 is prevented from moving from its first configuration to its second configuration when the liquid extraction device 400 is in a horizontal orientation.

The spherical blocking elements 718 are free to move under gravity within the arcuate channels 716 defined by the safety mechanism 700 and the interior surface 516 of the first cylinder portion 510. As shown in FIG. 11, when the liquid extraction device 400 is in the horizontal orientation, one of the spherical blocking elements 718 is positioned only partially within the recess 740 defined by the central cylinder portion 702, lower flange section 704, upper flange section 706 and angled shoulder 710. This means that the blocking element 718 engages the angled end wall 562 at the end of one of the restrictions 556. The blocking element 718 therefore becomes wedged between the angled shoulder 710 of the safety mechanism 700 and the angled end wall 562 of the restriction 556 protruding from the interior surface 516 of the first cylinder portion 510. The wedged blocking element 718 prevents movement of the safety mechanism 700 relative to the cylinder 500, meaning that the safety mechanism 700 cannot be actuated from the first safety mechanism configuration to the second safety mechanism configuration.

It will be appreciated that the cooperation of the blocking elements 718 and the arcuate channels 716 prevents movement of the safety mechanism 700 relative to the cylinder 500 when the liquid extraction device 400 is in other orientations, besides horizontal. In particular, the blocking elements 718 cooperate with the arcuate channels 716 to prevent movement of the safety mechanism in all orientations except orientations close to vertical.

In contrast, FIGS. 12A and 12B show how the safety mechanism 700 is allowed to move from its first configuration to its second configuration when the liquid extraction device 400 is in an orientation close to vertical.

As shown in FIG. 12A, the spherical blocking elements 718 move under gravity and fall into the recesses 740 defined by the central cylinder portion 702, lower flange sections 704, upper flange sections 706 and angled shoulders 710. This means that the blocking elements 718 are disposed within the recesses 740 and are not wedged between the angled shoulders 710 of the safety mechanism 700 and the angled end walls 562 of the restrictions 556. As the blocking elements 718 are disposed within the recesses 740, they do not obstruct movement of the safety mechanism 700, meaning that the safety mechanism 700 can be actuated downwards from its first configuration to its second configuration once the resiliently deformable clips 720 have been disengaged from the ends of the ribs 552 (e.g. as shown in FIG. 12B).

Variations or modifications to the systems and methods described herein are set out in the following paragraphs.

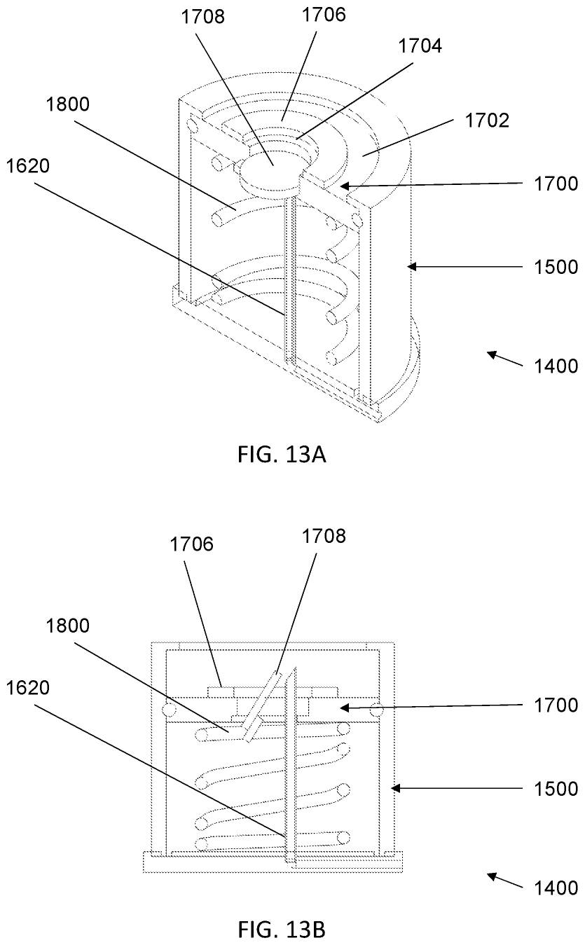

As shown in FIGS. 13A and 13B, an alternative safety mechanism 1700 may be implemented in the form of an actuatable platform 1702 comprising an aperture 1704. The platform 1702 comprises an annular soft sealing overmould 1706, which engages the cap 15 of a blood collection tube 11. The aperture 1704 is covered by a cap 1708 that is hingedly attached to the platform 1702. The cap 1708 hinges upwardly when a force is applied to the cap 1708 from below the cap 1708, but is prevented from hinging downwardly by the platform 1702. As with the liquid extraction device 400 described above, a needle 1620 is disposed beneath the safety mechanism 1700 (specifically, beneath the cap 1708), and a spring 1800 biases the safety mechanism 1700 away from the second safety mechanism configuration. The needle 1620 is concealed by the cap 1708 of the actuatable platform 1702.

In operation, a blood collection tube 11 is engaged with the soft sealing overmould 1706 when the safety mechanism 1700 is in the first safety mechanism configuration. A downward force is then applied to the blood collection tube 11 by the user. The annular shape of the cap 15 of the blood collection tube 11 means that a downwards force is applied to the actuatable platform 1702, but not the cap 1708. The downwards force applied to the actuatable platform 1702 brings the needle 1620 into contact with the cap 1708, and results in an upwards force being applied to the cap 1708 by the needle 1620. The upwards force applied by the needle 1620 results in the cap 1708 hinging upwards, thereby allowing the needle 1620 to protrude through the aperture 1704, as shown in FIG. 13B (i.e. the second safety mechanism configuration). Therefore, the safety mechanism 1700 reveals the needle 1620 when in the second safety mechanism configuration.

In contrast, when a user applies a downward force to the safety mechanism 1700 using their finger, the force is applied to the cap 1708. The downward force applied to the cap 1708 counteracts any upward force applied to the cap 1708 by the needle 1620, meaning that the needle does not protrude through the aperture 1704 and the user's finger is protected.

Although not shown in FIGS. 13A and 13B, the safety mechanism 1700 may be used in conjunction with a liquid extraction mechanism (e.g. a piston) configured to extract liquid from the blood collection tube 11, in a similar manner to the piston 600 of the liquid extraction device 400 described above.

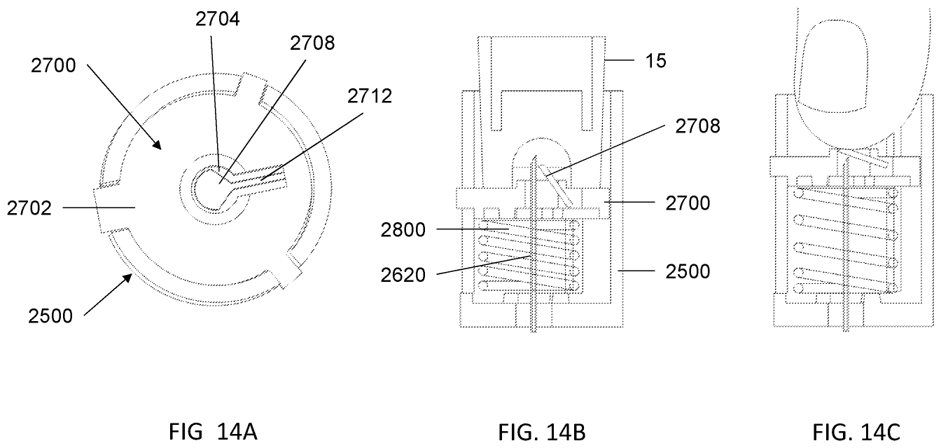

FIGS. 14A to 14C show a further alternative safety mechanism 2700 which operates in the same manner as the safety mechanism 1700 described above. In contrast to the safety mechanism 1700, the actuatable platform 2702 of the safety mechanism 2700 includes a hinged cap 2708 that is integral with the actuatable platform 2702, such that the hinged cap 2708 is provided in the form of a living hinge 2712.

The hinged cap 2708 allows a needle 2620 to pass through an aperture 2704 in the actuatable platform 2702 when an annular force is applied by, for example, a cap 15 of a blood collection tube 11, as shown in FIG. 14B. However, the cap 2708 prevents the needle 2620 from passing through the aperture 2704 when a force is applied to the actuatable platform 2702 (specifically the cap 2708) by a user's finger, as shown in FIG. 14C.

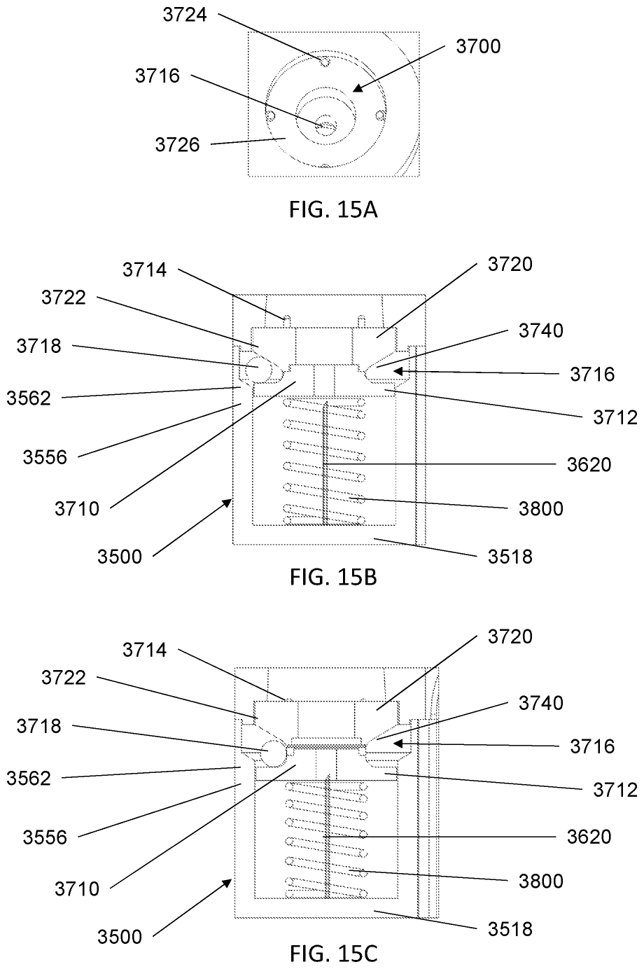

FIGS. 15A to 15C show a further alternative safety mechanism 3700. As shown in FIG. 15B, the safety mechanism 3700 comprises a lower safety mechanism portion 3710 and an upper safety mechanism portion 3720. The safety mechanism 3700 is actuatable within a cylinder 3500 that comprises an annular restriction 3556 extending around its circumference. The restriction 3556 extends from an end wall 3518 of the cylinder 3500 and terminates at an annular angled end wall 3562. The safety mechanism 3700 is moveable within the region of the cylinder 3500 that comprises the restriction 3556.

The upper safety mechanism portion 3720 and the lower safety mechanism portion 3710 each include apertures 3726, 3716 that are aligned with one another, such that a needle 3620 can extend through the apertures 3726, 3716 when the safety mechanism 3700 is actuated to the second safety mechanism configuration. The lower safety mechanism portion 3710 is biased upwards by a spring 3800 housed within the cylinder 3500.

The upper safety mechanism portion 3720 and lower safety mechanism portion 3710 cooperate to define a recess 3740 configured to house a spherical blocking element 3718. Specifically, the upper safety mechanism portion 3720 comprises an annular angled shoulder 3722 that defines an upper part of the recess 3740, while the lower safety mechanism portion 3710 comprises an annular flange 3712 that defines a lower part of the recess 3740.

Together, the interior surface 3516 of the cylinder 3500, the angled end wall 3562 of the restriction 3556, and the recess 3740 define an annular channel 3716 around which the spherical blocking element 3718 is free to move under gravity.

The lower safety mechanism portion 3710 is actuatable from a first position relative to the upper safety mechanism portion 3720, to a second position relative to the upper safety mechanism portion 3720. To allow the lower safety mechanism portion 3710 to be actuated, the lower safety mechanism portion 3710 comprises one or more protrusions (shown in FIGS. 15A and 15B in the form of four prongs 3714) extending through corresponding holes 3724 in the upper safety mechanism portion 3720. The prongs 3714 protrude from the top surface of the upper safety mechanism portion 3720 when the lower safety mechanism portion 3710 is in the first position. The prongs 3714 and corresponding holes 3724 are provided in an annular pattern so that a force is applied to the ends of the prongs 3714 when an annular force profile is applied (e.g. by a cap 15 of a blood collection tube 11).

When the lower safety mechanism portion 3710 is in the first position, the volume of the recess 3740 is reduced, meaning that the blocking element 3718 cannot be fully housed within the recess 3740. When in this position, shown in FIG. 15B, the blocking element 3718 protrudes partly from the recess 3740, meaning that it engages the angled end wall 3516 within the cylinder 3500. The engagement of the blocking element 3718 with the angled end wall 3516 prevents downward movement of the safety mechanism 3700 within the cylinder 3500, thereby concealing the needle.

To actuate the lower safety mechanism portion 3710 to the second position, a downward force is applied to the prongs 3714 protruding from the upper safety mechanism portion 3720. The force applied to the prongs 3714 pushes the lower safety mechanism portion 3710 downwards by compressing the spring 3800. The downward movement of the lower safety mechanism portion 3710 opens up the recess 3740, which allows the blocking element 3718 to be fully housed within the recess 3740, as shown in FIG. 15C.

The blocking element 3718 and annular channel 3716 then cooperate in the same manner as described with reference to FIGS. 11, 12A and 12B. Specifically, the blocking element 3718 engages with the angled end wall 3562 to prevent movement of the safety mechanism 3700 within the cylinder 3500 when a liquid extraction device comprising the safety mechanism 3700 is in an orientation that is not close to vertical.

The blocking element 3718 falls into the recess 3740 under gravity such that it is fully housed within the recess 3740 when the liquid extraction device is in an orientation close to vertical, thereby permitting movement of the safety mechanism 3700 within the cylinder 3500. This allows the safety mechanism 3700 to be actuated from its first configuration to its second configuration, thereby revealing the needle, which protrudes through the apertures 3716, 3726.

Although the above implementations are described with reference to extracting liquid from a blood collection tube such as a Vacutainer (RTM), it will be appreciated that the implementations described above are also suitable for extracting liquid from other forms of pierceable liquid storage containers, which may differ in size and/or shape from blood collection tubes. In such cases, the dimensions of the safety mechanism, receptacle and piston may be adapted to the size and shape of the liquid storage container from which liquid is to be extracted. For example, although the above implementations are described with reference to a cylindrical tube in which the blood collection tube 11 is received, it will be appreciated that other cross-sections of tubes, pistons and safety mechanisms may be implemented to allow for extraction of liquid from other liquid storage containers.

Additionally, although the above implementations use a liquid storage container interface (e.g. a blood collection tube interface) in the form of one or more needles, other liquid storage container interfaces may be implemented, provided that they are capable of providing a fluidic connection to a volume of liquid within a liquid storage container (e.g. to the volume of liquid 19 within the blood collection tube 11). The safety mechanisms described herein may reveal and conceal such other liquid storage container interfaces.

Although the safety mechanism 700 is described above as part of a liquid extraction device 400 that comprises an actuatable liquid extraction mechanism, it will be appreciated that the safety mechanism 700 is also compatible with a static liquid extraction mechanism (e.g. a static needle), where liquid is extracted from a liquid storage container (e.g. a blood collection tube) by operation of a pump. Further, it will be appreciated that the safety mechanism 700 described above may be used to protect a user against a needle that is disposed within a receptacle for any other purpose besides extracting liquid from a liquid storage container. That is, the safety mechanism 700 is not limited to being implemented as part of a liquid extraction device.

The term “needle” in the above implementations is not intended to be limited to metal needles, and is intended to cover other piercing elements that are configured to pierce a septum of a blood collection tube, such as piercing elements that are integral with a piston.

Although certain implementations are described above using resiliently deformable elements such as springs, it will be appreciated that other resiliently deformable elements may be implemented.

Although certain implementations use one or more sealing elements attached to a piston, the sealing elements may alternatively be attached to an interior wall of the cylinder. Although the above implementations describe sealing elements in the form of O-ring seals, the sealing elements may alternatively be provided in the form of a moulded plastic seal, or an over-moulded rubber seal.

Finally, although the above implementations are described with reference to a force applied by a user to actuate the liquid extraction mechanism, it will be appreciated that the liquid extraction mechanism may alternatively be actuated without requiring user input (e.g. under control of a motor).

As a general point, although the above implementations are described with reference to extracting liquid for use in a diagnostic test carried out using a cartridge, it will be appreciated that the liquid extraction devices described above are suitable for extracting liquid from a liquid storage container (e.g. a blood collection tube) for a wide range of other purposes.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A liquid extraction device for extracting liquid from a liquid storage container, the liquid extraction device comprising:
a receptacle configured to receive a portion of the liquid storage container;
a liquid storage container interface housed within the receptacle, wherein the liquid storage container interface is configured to provide a fluidic connection to a volume of liquid within the liquid storage container when the liquid storage container is connected to the liquid storage container interface; and
a safety mechanism actuatable from a first safety mechanism configuration to a second safety mechanism configuration, wherein the safety mechanism is configured to conceal the liquid storage container interface when the safety mechanism is in the first safety mechanism configuration, and wherein the safety mechanism is configured to reveal the liquid storage container interface when the safety mechanism in the second safety mechanism configuration.

2. A liquid extraction device according to claim 1, wherein the liquid storage container interface comprises at least one needle configured to provide the fluidic connection to the volume of liquid within the liquid storage container.

3. A liquid extraction device according to claim 1 or claim 2, further comprising a resiliently deformable element configured to be deformed when the safety mechanism is actuated from the first safety mechanism configuration to the second safety mechanism configuration;
wherein the resiliently deformable element is configured to bias the safety mechanism away from the second safety mechanism configuration towards the first safety mechanism configuration.

4. A liquid extraction device according to any of claims 1 to 3, wherein the safety mechanism comprises a release mechanism configured to engage a portion of the receptacle when the safety mechanism is in the first safety mechanism configuration.

5. A liquid extraction device according to claim 4, wherein the release mechanism is configured to permit actuation of the safety mechanism from the first safety mechanism configuration to the second safety mechanism configuration when the release mechanism is disengaged from the portion of the receptacle.

6. A liquid extraction device according to claim 4 or claim 5, wherein the release mechanism comprises at least two clips, wherein the release mechanism is configured to be disengaged from the portion of the receptacle when a force is simultaneously applied to each of the at least two clips.

7. A liquid extraction device according to any of claims 1 to 6, further comprising a blocking element configured to:
prevent actuation of the safety mechanism from the first safety mechanism configuration to the second safety mechanism configuration when the liquid extraction device is in a first orientation; and
permit actuation of the safety mechanism from the first safety mechanism configuration to the second safety mechanism configuration when the liquid extraction device is in a second orientation different to the first orientation.

8. A liquid extraction device according to claim 7, wherein the blocking element is configured to engage a restriction within the receptacle to prevent actuation of the safety mechanism from the first safety mechanism configuration to the second safety mechanism configuration when the liquid extraction device is in the first orientation.

9. A liquid extraction device according to claim 7 or claim 8, wherein the second orientation is a substantially vertical orientation.

10. A liquid extraction device according to any of claims 1 to 9, further comprising a liquid extraction mechanism actuatable from a first liquid extraction mechanism configuration to a second liquid extraction mechanism configuration, wherein the liquid extraction mechanism is configured to provide a pressure difference between a volume of gas in the liquid storage container and the liquid extraction outlet, when the liquid extraction mechanism is actuated from the first liquid extraction mechanism configuration to the second liquid extraction mechanism configuration.

11. A liquid extraction device according to claim 10, wherein the safety mechanism is configured to actuate the liquid extraction mechanism from the first liquid extraction mechanism configuration to the second liquid extraction mechanism configuration.

12. A liquid extraction device according to claim 10 or claim 11, wherein the liquid extraction mechanism is actuatable from the first liquid extraction mechanism configuration to the second liquid extraction mechanism configuration once the safety mechanism has been actuated to the second safety mechanism configuration.

13. A liquid extraction device according to any of claims 10 to 12, further comprising a first engagement mechanism configured to prevent actuation of the liquid extraction mechanism from the first liquid extraction mechanism configuration in a direction opposite to the direction of actuation from the first liquid extraction mechanism configuration to the second liquid extraction mechanism configuration.

14. A liquid extraction device according to any of claims 10 to 13, further comprising a second engagement mechanism configured to retain the liquid extraction mechanism in the second liquid extraction mechanism configuration once the liquid extraction mechanism has been actuated to the second liquid extraction mechanism configuration.

15. A liquid extraction device according to claim 14, wherein the second engagement mechanism is configured to provide an audible click once the liquid extraction mechanism has been actuated to the second liquid extraction mechanism configuration.

16. A liquid extraction device according to any of claims 1 to 15, wherein the safety mechanism comprises an aperture;
wherein the liquid storage container interface does not extend through the aperture in the safety mechanism when the safety mechanism is in the first safety mechanism configuration; and
wherein the liquid storage container interface extends through the aperture in the safety mechanism when the safety mechanism is in the second safety mechanism configuration.

17. A liquid handling apparatus comprising:
a liquid handling device comprising one or more conduits; and
a liquid extraction device according to any of claims 1 to 16;
wherein the liquid extraction device is in fluidic communication with at least one of the one or more conduits.
